(19) United States
(12) Patent Application Publication
(10) Pub. No.: US 2024/0293800 A1
(43) Pub. Date: Sep. 5, 2024

(54) ADSORBENT FILAMENTS AND METHODS OF FORMING THEREOF

(71) Applicant: SAINT-GOBAIN CERAMICS & PLASTICS, INC., Worcester, MA (US)

(72) Inventors: James August MCCARTHY, Streetsboro, OH (US); Jingyu SHI, Hudson, OH (US); Stephen Lee DAHAR, Solon, OH (US); Patrick NGUYEN VAN NUOI, Cavaillon (FR)

(21) Appl. No.: 18/258,600

(22) PCT Filed: Dec. 16, 2021
(86) PCT No.: PCT/US2021/072974

§ 371 Date: Jun. 21, 2023

Related U.S. Application Data
(60) Provisional application No. 63/128,310, filed on Dec. 21, 2020.

(51) Int. Cl. B01J 20/30; B01J 20/04; B01J 20/28

(52) U.S. Cl. CPC B01J 20/3007; B01J 20/04; B01J 20/28004; B01J 20/28011; B01J 20/28023; B01J 20/28054

(57) ABSTRACT

A method of forming a batch of porous adsorbent filaments may include providing a precursor mixture, forcing the precursor mixture at a fixed rate through an orifice and then through a multiplicity of perforations in a belt, where the belt moves across and in tight registry with said orifice to form a batch of precursor porous adsorbent filaments, and drying the batch of precursor porous adsorbent filaments to form the batch of porous adsorbent filaments. The batch of porous adsorbent filaments may have a moisture content of at least about 20 wt. %.

### TECHNICAL FIELD

The following is directed generally to adsorbent filaments, and more particularly to lithium bayerite adsorbent filaments and methods of making the same.

### BACKGROUND ART

Adsorbent particles are commonly used as the solid portion of an adsorbent column and must be packed tightly to improve adsorbent kinetics within the column. Consistent shape and size of adsorbent particles used in an adsorbent column facilitate tighter packing density and, ultimately, improved performance of the adsorbent column. Accordingly, the industry continues to demand improved mass manufacturing of adsorbent particles that have controlled and consistent size and shape.

### SUMMARY OF THE INVENTION

According to a first aspect, a method of forming a batch of porous adsorbent filaments may include providing a precursor mixture, forcing the precursor mixture at a fixed rate through an orifice and then through a multiplicity of perforations in a belt, where the belt moves across and in tight registry with said orifice to form a batch of precursor porous adsorbent filaments, and drying the batch of precursor porous adsorbent filaments to form the batch of porous adsorbent filaments. The batch of porous adsorbent filaments may have a moisture content of at least about 20 wt. %.

According to yet another aspect, a batch of porous adsorbent filaments may have an average aspect ratio (L/D) of at least about 0.5. The batch of porous adsorbent filament may further have a moisture content of at least about 20 wt. %.

According to still another aspect, a system for forming a batch of porous adsorbent filaments may include an application zone that may include a shaping assembly. The shaping assembly may include a reservoir configured to force a precursor mixture at a fixed rate through an orifice and then through a multiplicity of perforations in a belt. The belt may move across and in tight registry with said orifice to form a batch of precursor porous adsorbent filaments. The system may further include a drying zone that may include a first heat source and it may be configured to dry the batch of precursor porous adsorbent filaments to form the batch of porous adsorbent filaments.

According to another aspect, a method of forming a batch of porous lithium bayerite adsorbent filaments may include providing a precursor mixture, forcing the precursor mixture at a fixed rate through an orifice, and then through a multiplicity of perforations in a belt, where the belt moves across and in tight registry with said orifice to form a batch of precursor porous adsorbent filaments, and drying the batch of precursor porous lithium bayerite adsorbent filaments to form the batch of porous adsorbent filaments. The batch of porous lithium bayerite adsorbent filaments may have a moisture content of at least about 20 wt. %.

According to yet another aspect, a batch of porous lithium bayerite adsorbent filaments may have an average aspect ratio (L/D) of at least about 0.5. The batch of porous adsorbent filament may further have a moisture content of at least about 20 wt. %.

According to still another aspect, a system for forming a batch of porous lithium bayerite adsorbent filaments may include an application zone that may include a shaping assembly. The shaping assembly may include a reservoir configured to force a precursor mixture at a fixed rate through an orifice and then through a multiplicity of perforations in a belt. The belt may move across and in tight registry with said orifice to form a batch of precursor porous adsorbent filaments. The system may further include a drying zone that may include a first heat source and it may be configured to dry the batch of precursor porous lithium bayerite adsorbent filaments to form the batch of porous adsorbent filaments.

### BRIEF DESCRIPTION OF THE DRAWINGS

The present disclosure can be better understood, and its numerous features and advantages made apparent to those skilled in the art by referencing the accompanying drawings.

FIG. 1 is an illustration of a flowchart of a method of making a batch of porous adsorbent filaments in accordance with an embodiment.

FIG. 2 includes a schematic of a system for forming a batch of porous adsorbent filaments in accordance with an embodiment.

FIG. 3 is an illustration of a flowchart of a method of making a batch of porous adsorbent filaments in accordance with an embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

The use of the same reference symbols in different drawings indicates similar or identical items.

### DETAILED DESCRIPTION OF THE PREFERRED EMBODIMENT(S)

The following description, in combination with the figures, is provided to assist in understanding the teachings disclosed herein. The following discussion will focus on specific implementations and embodiments of the teachings. This discussion is provided to assist in describing the teachings and should not be interpreted as a limitation on the scope or applicability of the teachings.

The term “averaged,” when referring to a value, is intended to mean an average, a geometric mean, or a median value. As used herein, the terms “comprises,” “comprising,” “includes,” “including,” “has.” “having,” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. As used herein, the phrase “consists essentially of” or “consisting essentially of” means that the subject that the phrase describes does not include any other components that substantially affect the property of the subject.

Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Further, references to values stated in ranges include each and every value within that range. When the terms “about” or “approximately” precede a numerical value, such as when describing a numerical range, it is intended that the exact numerical value is also included. For example, a numerical range beginning at “about 25” is intended to also include a range that begins at exactly 25. Moreover, it will be appreciated that references to values stated as “at least about,” “greater than,” “less than,” or “not greater than” can include a range of any minimum or maximum value noted therein.

Embodiments described herein are generally directed to the formation of a batch of porous adsorbent filaments having a generally elongated aspect ratio and a particular moisture content.

For purposes of embodiments described herein, adsorption is defined as the separation of adsorbate components of a gas or a liquid mixture by the transfer of one or more components to a surface of adsorbent filaments. Adsorbent filaments are defined as porous solid particulate materials configured for, useful for, or directly applied for the uptake and immobilization of a species (e.g., a solid, a liquid, a gas, a molecule, an atom, or an ion) from a surrounding medium (e.g., a solid, a liquid, or a gas) by one or more adsorption processes including physisorption, chemisorption, and intercalation and ion exchange. The adsorbed components are held to the surface by intermolecular forces, including Van der Waals and electrostatic forces. The adsorbed components may be subsequently removed or desorbed allowing as a consequence the adsorbent, or adsorbent filaments, to be reused and advantageously the adsorbed components to be recovered (and concentrated). The attractive forces in adsorption are typically weaker than those of chemical bonds. Therefore, desorption of the adsorbate can be achieved by overcoming the energy of the attractive forces such as by increasing the temperature, by reducing its partial pressure or concentration, or by displacing it with another adsorbate (this is, in particular, the case for ion exchange and can be named as an elution process).

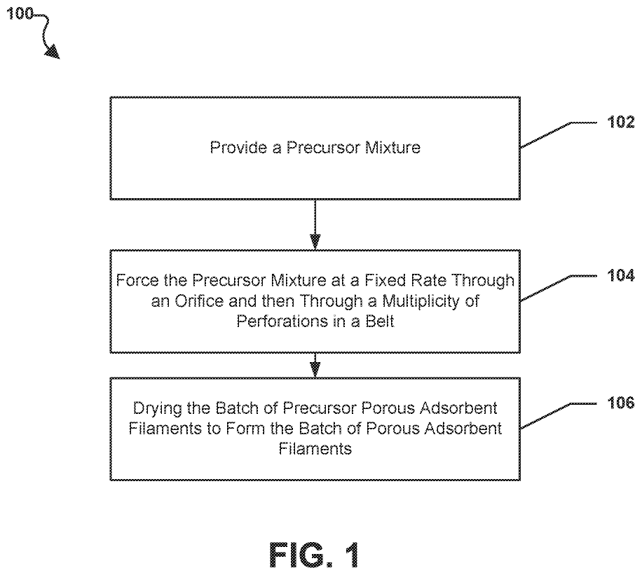

Referring initially to a method of forming a batch of shaped adsorbent filaments, FIG. 1 illustrates a porous adsorbent filament forming process generally designated 100. Porous adsorbent filaments forming process 100 may include a first step 102 of providing a precursor mixture, a second step 104 of forcing the precursor mixture at a fixed rate through an orifice and then through a multiplicity of perforations in a belt, where the belt moves across and in tight registry with said orifice to form a batch of precursor porous adsorbent filaments, and a third step 106 of drying the batch of precursor porous adsorbent filaments to form the batch of porous adsorbent filaments.

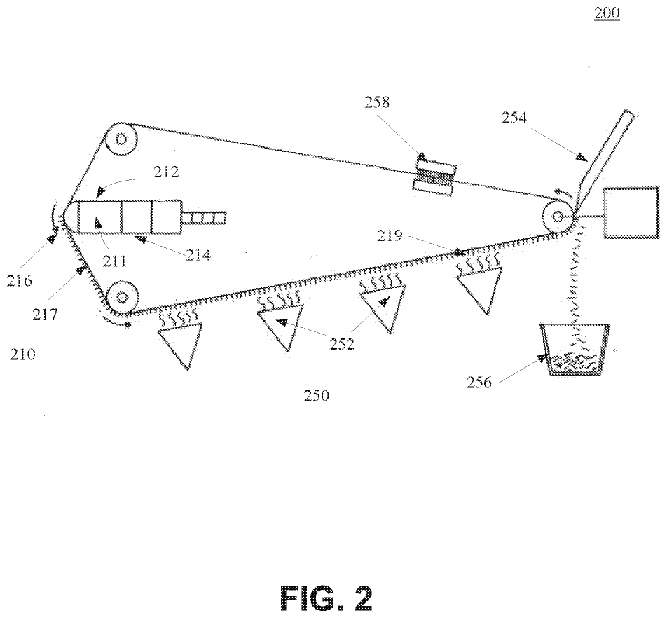

FIG. 2 includes an illustration of a system that may be used in forming a batch of porous adsorbent filaments in accordance with embodiments described herein. As illustrated, a system 200 may include an application zone 210 and a drying zone 250. As shown in FIG. 2, the application zone 210 may include a reservoir 212 for holding a precursor mixture 211, a force means 214 (e.g., a piston extruder) configured to force the precursor mixture 211 through a continuous, perforated belt loop 216 while the belt loop 216 is in motion. According to particular embodiments, as the belt loop 216 moves past the forcing means 214, the precursor mixture emerges from the side of the belt loop 216, opposite of the force means 214, as a batch of precursor adsorbent filaments 217, which are inherently so sticky that they would adhere to each other if permitted to make contact. The batch of precursor adsorbent filaments 217 adhere to the belt loop 216 as it moves away from the forcing means 214, out of the application zone 210 and into the drying zone 250. According to a certain embodiment, the precursor adsorbent filaments 217 are treated within the drying zone to make them non-sticky, preferably dried or de-watered by a drying means 252, such as hot air blowers, positioned in the drying zone 250 downstream of the forcing means 214, which transforms the batch of precursor adsorbent filaments 217 into a batch of porous adsorbent filaments 219. As used herein, “downstream” means a position in the direction of the forward motion of the belt loop 216.

According to certain embodiments, keeping the precursor adsorbent filaments 217 apart until they are no longer adherent to each other permits the use of lower percent solids dispersions. This in turn facilitates the use of smaller openings in the belt loop, resulting in the production of very fine grit sizes without the need for classification. Also, the lower solids enable the use of lower pressures when employing an extruder as the forcing means 214.

According to certain embodiments, the drying means 252 is preferably a drying means which may be any suitable means such as a drying chamber, hot air blowers, radiant heaters, microwaves, dry air or gas, or a water-extracting solvent.

In accordance with an embodiment, the drying means 252 can act at a particular temperature. For example, the drying means 252 can act at a temperature of not greater than about 300° C. In other embodiments, the drying means 252 can act at a temperature of not greater than about 250° C., not greater than about 200° C., not greater than about 180° C., not greater than about 160° C., not greater than about 140° C., not greater than about 120° C., not greater than about 100° C., not greater than about 90° C., not greater than about 80° C., or even not greater than about 70° C. Some suitable temperatures for drying can be at least about 10° C., such as at least about 15° C., at least about 20° C., at least about 25° C., at least about 30° C., at least about 35° C., or even at least about 40° C. It will be appreciated that in certain non-limiting embodiments, the drying means 252 can act at a temperature within a range between any of the temperatures noted above.

Alternatively, the drying means 252 can be a coating means which coats the surfaces of the filamentary particles with a very fine dust. Suitable such dusts for alumina filamentary particles include alpha alumina or boehmite, since these materials will not be deleterious to the eventual use of the particles.

According to still other embodiments and as shown in FIG. 2., after the belt loop 216 with the batch of precursor adsorbent filaments 217 batch of porous adsorbent filaments 219 thereon passes by or through the drying means 252, the batch of porous adsorbent filaments 219 are removed from the belt loop by a removing means 254 located downstream of the drying means 252. Suitable removing means 254 include, for example, a doctor blade (shown), wire, brush, air blast, or other suitable means.

According to yet other embodiments and as shown in FIG. 2, the batch of porous adsorbent filaments 219 removed from the belt loop 216 are collected in collecting means 256 and, if necessary, screened to remove dust. The batch of porous adsorbent filaments 219 so produced are finished, loose grain materials, which do not require further cutting to length with each filamentary particle having substantially the same aspect ratio, provided that the pressure exerted by the forcing means 214 was substantially constant across its entire face.

According to still other embodiments, and as shown in FIG. 2, after the batch of porous adsorbent filaments 219 are removed for final processing, the belt loop 216 continues around its path. While not always required, the belt loop may pass through a cleaning means 258, such as a rotating brush (shown), so as to remove any remaining adsorbent material and thereby avoid any clogging problems. Suitable cleaning means include vacuum, stiff wire brushes, water solvent jets, ultrasound, and air blasts.

According to particular embodiments, the forcing means 216 is preferably an extruder such as a horizontal piston extruder, an auger extruder, or other devices such as a pump, doctor blade, or roller. As shown in FIG. 2, the forcing means is positioned immediately adjacent to and in tight register with the belt loop 216. In the case of an extruder such as a horizontal piston extruder, the belt loop is stretched across the exit slot of the extruder so that the material that exits the extruder passes immediately through the perforated belt loop 216.

According to yet other embodiments, the belt loop 216 may be made of any suitable material such as stainless steel or other acid and high temperature resistant material. The perforations in the belt loop may be obtained by using a wire mesh of the desired opening size or by using punched hole, laser cut, chemically etched, or electro-etched sheets. Alternatively, the belt may be a “sacrificial” belt that is used a single time and not repeatedly as in a continuous loop. The perforations in the belt may be of any size or shape depending upon the desired size and shape of the filamentary particles to be produced. For example, the perforations may be designed to produce generally cylindrical filamentary particles after firing having a diameter of at least about 0.5 and not greater than about 20. According to still other embodiments, the perforations in the belt loop 216 may be configured to produce filamentary particles of various shapes, including having square, rectangular, triangular, and star shaped cross sections. Generally, the perforations are spaced such that the particles do not touch each other while adhered to the belt. On the other hand, the spacing should not be so great that the internal pressure of the forcing means is excessive. It is found that suitable belts generally contain from about 20% to about 40% of perforations in the surface area. Usually, about 30% of the belt surface area is represented by the perforations.

According to certain embodiments, the length and thereby the aspect ratio of the batch of porous adsorbent filaments 219 may be controlled by controlling the velocity at which the belt loop 216 moves; the greater the velocity the lower the aspect ratio of the batch of porous adsorbent filaments 219. Provided (i) the belt loop travels at a steady rate during a forcing run, (ii) each of the perforations is of equivalent size, and (iii) the pressure is constant across the entire face of the forcing means the aspect ratio of the filamentary particles produced during that run will all be substantially the same.

In addition, the aspect ratio of the batch of porous adsorbent filaments 219 is dependent on the delivery rate of the dispersion to the orifice of the forcing means 214. This in turn is controlled by the pressure of the extruder, the pH, and the solids content of the aqueous dispersion being processed. Higher delivery rates will produce greater aspect ratios, as will lower solids content. Generally, pressures of about 2 psi to about 500 psi or more will be used with those compositions having a higher solids content requiring the higher pressures.

Referring now to the precursor mixture (i.e., the precursor mixture described in reference to forming process 100 and/or the precursor mixture 211 described in reference to system 200), according to certain embodiments, the precursor mixture may include any combination of materials necessary for forming a shaped adsorbent filaments. For example, the precursor mixture may include ceramic components, such as, aluminas, boehmites, bayerites, aluminum hydroxides, silicas, titanias, zirconias, and combinations thereof. According to still other embodiments, the precursor mixture may also include metal components, such as, transition metals including Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, Au, Rf, Db, Sg, Bh, Hs (i.e., transition metals contained in groups 3-11 of the periodic table) and combinations thereof. According to yet other embodiments, the precursor mixture may further include alkali and alkaline earth metal components, such as, Li, Be, Na, Mg, K, Ca, Rb, Sr, Cs, Ba, and combinations thereof. According to still other embodiments, the precursor mixture may include carbon, metal organic framework (MOF), or combinations thereof.

Referring now to the batch of porous adsorbent filaments (i.e., the batch of porous adsorbent filaments described in reference to forming process 100 and/or the batch of adsorbent filaments 211 described in reference to system 200), according to certain embodiments, the batch of porous adsorbent filaments may include ceramic components, such as, aluminas, boehmites, bayerites, aluminum hydroxides, silicas, titanias, zirconias, and combinations thereof. According to still other embodiments, the batch of porous adsorbent filaments may also include metal components, such as, transition metals including Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, Au, Rf, Db, Sg, Bh, Hs (i.e., transition metals contained in groups 3-11 of the periodic table) and combinations thereof. According to yet other embodiments, the batch of porous adsorbent filaments may further include alkali and alkaline earth metal components, such as, Li, Be, Na, Mg, K, Ca, Rb, Sr, Cs, Ba, and combinations thereof. According to still other embodiments, the batch of porous adsorbent filaments may include, carbon, metal organic framework (MOF) or combinations thereof.

According to still other embodiments, the batch of porous adsorbent filaments may have particular moisture content. For purposes of embodiments described herein, the moisture content of a sample of the batch of porous adsorbent filaments is determined using the Mettler Toledo HB43 moisture analyzer. The lid of the analyzer is closed to tare the instrument. A sample of the batch of porous adsorbent filaments of at least 0.5 g and less than 1 g is placed on the balance, and the lid is closed to begin heating. The balance is heated to a maximum temperature of 155° C. while continuously measuring the sample's mass. As the temperature increases, the mass of the sample decreases as water evaporates. This mass is automatically converted to percent solid (% solid=[mass]/[initial mass]) which is displayed by the analyzer continuously to the nearest 0.01 g. When the sample reaches a stable percent solid reading for 30 seconds, the heating and measurement terminate. The displayed value is taken to be the percentage of solid material in the sample. This value is then subtracted from 1 to yield the percentage of water, or moisture content, of the sample.

According to particular embodiments, the batch of porous adsorbent filaments may have a moisture content of at least about 20 wt. % based on a total weight of the batch of adsorbent filaments, such as, at least about 21 wt. % or at least about 22 wt. % or at least about 23 wt. % or at least about 24 wt. % or at least about 25 wt. % or at least about 26 wt. % or at least about 27 wt. % or at least about 28 wt. % or at least about 29 wt. % or at least about 30 wt. % or at least about 31 wt. % or at least about 32 wt. % or at least about 33 wt. % or at least about 34 wt. % or at least about 35 wt. % or at least about 36 wt. % or at least about 37 wt. % or at least about 38 wt. % or at least about 39 wt. % or at least about 40 wt. % or at least about 41 wt. % or at least about 42 wt. % or at least about 43 wt. % or at least about 44 wt. % or even at least about 45 wt. %. According to still other embodiments, the batch of porous adsorbent filaments may have a moisture content of not greater than about 60 wt. % based on a total weight of the batch of adsorbent filaments, such as, not greater than about 58 wt. % or not greater than about 56 wt. % or not greater than about 54 wt. % or not greater than about 52 wt. % or not greater than about 50 wt. %. It will be appreciated that the moisture content of the batch of porous adsorbent filaments may be any value between, and including, any of the minimum and maximum values noted above. It will be further appreciated that the moisture content of the batch of porous adsorbent filaments may be within a range between, and including, any of the minimum and maximum values noted above.

According to yet other embodiments, the batch of porous adsorbent filaments may include a plurality of filaments having a columnar shape with a particular cross-sectional shape along the length of the filaments. According to still other embodiments, the plurality of filaments may have a circular cross-sectional shape along the length of the filaments. According to yet other embodiments, the plurality of filaments may have an oval cross-sectional shape along the length of the filament. According to still other embodiments, the plurality of filaments may have a polygonal cross-sectional shape along the length of the filament.

According to still other embodiments, the filaments in the batch of porous adsorbent filaments, which has a columnar shape, may have basic dimensions including length (L), cross-sectional diameter (D), and aspect ratio (AR). For purposes of embodiments described herein, the length (L) of a filament is defined as the greatest dimension perpendicular to the cross-sectional shape of the filament. The cross-sectional diameter (D) is the greatest dimension of the cross-sectional shape of the filament. The aspect ratio (AR) of filaments in the batch of porous adsorbent filaments is equal to the length (L) of a filament in the batch of porous adsorbent filaments divided by the cross-sectional diameter (D) of the filament in the batch of porous adsorbent filaments.

It will be appreciated that all measurements, including average length (L), average cross-sectional diameter (i.e., equivalent diameter) (D), and average particle aspect ratio (AR), of a particular batch of shaped lithium bayerite adsorbent filaments are measured using images collected with an Olympus DSX510 digital optical microscope. Filaments of a sample batch are placed on the microscope stage and distributed in a monolayer. The height of the lens is adjusted to bring the filament boundaries into focus. The “Live Panorama” tool is used to stitch together a 9 frame by 9 frame image. Measurements of length and diameter are made for at least 20 filaments from the image using the “Measure” tool within the Olympus software. Aspect ratio (AR) of a given filament is calculated by dividing the length by diameter (L/D).

It will be further appreciated that all filament size measurements (i.e., D, L, and AR) may be described herein in combination with D-Values (i.e., D10, D50, and D90), which may be understood to represent the distribution intercepts for 10%, 50% and 90% of the number of filaments of a particular batch of porous adsorbent filaments. For example, a particular batch of filaments may have a Diameter D10 value (i.e., D₁₀) defined as the diameter at which 10% of the sample's mass is comprised of filaments with a diameter less than this value, a particular batch of filaments may have a Diameter D50 value (i.e., D₅₀) defined as the diameter at which 50% of the sample's mass is comprised of filaments with a diameter less than this value, and a particular batch of filaments may have a Diameter D90 value (i.e., D₉₀) defined as the diameter at which 90% of the sample's mass is comprised of filaments with a diameter less than this value. Further, a particular batch of filaments may have a Length D10 value (i.e., L₁₀) defined as the length at which 10% of the sample's mass is comprised of filaments with a length less than this value, a particular batch of filaments may have a Length D50 value (i.e., L₅₀) defined as the length at which 50% of the sample's mass is comprised of filaments with a length less than this value, and a particular batch of filaments may have a Length D90 value (i.e., L₉₀) defined as the length at which 90% of the sample's mass is comprised of filaments with a length less than this value. Finally, a particular batch of filaments may have an Aspect Ratio D10 value (i.e., AR₁₀) defined as the aspect ratio at which 10% of the sample's mass is comprised of filaments with an aspect ratio less than this value, a particular batch of filaments may have an Aspect Ratio D50 value (i.e., AR₅₀) defined as the aspect ratio at which 50% of the sample's mass is comprised of filaments with an aspect ratio less than this value, and a particular batch of filaments may have an Aspect Ratio D90 value (i.e., AR₉₀) defined as the aspect ratio at which 90% of the sample's mass is comprised of filaments with an aspect ratio less than this value.

According to still other embodiments, the batch of porous adsorbent filaments may have a particular length (L) distribution span PLDS, where PLDS is equal to (L₉₀−L₁₀)/L₅₀, where L₉₀ is equal to a L₉₀ filament length (L) distribution measurement of the batch of porous adsorbent filaments, L₁₀ is equal to a L₁₀ filament length (L) distribution measurement, and L₅₀ is equal to a L₅₀ filament length (L) distribution measurement. According to certain embodiments, the batch of porous adsorbent filaments may have a length (L) distribution span PLDS of not greater than about 50%, such as, not greater than about 49% or not greater than about 48% or not greater than about 47% or not greater than about 46% or not greater than about 45% or not greater than about 44% or not greater than about 43% or not greater than about 42% or not greater than about 41% or even not greater than about 40%. It will be appreciated that the length (L) distribution span PLDS of the batch of porous adsorbent filaments may be any value between, and including, any of the minimum and maximum values noted above. It will be further appreciated that the length (L) distribution span PLDS of the batch of porous adsorbent filaments may be within a range between, and including, any of the minimum and maximum values noted above.

According to still other embodiments, the batch of porous adsorbent filaments may have a particular diameter (D) distribution span PDDS, where PDDS is equal to (D₉₀−D₁₀)/D₅₀, where D₉₀ is equal to a D₉₀ filament diameter (D) distribution measurement of the batch of porous adsorbent filaments, D₁₀ is equal to a D₁₀ filament diameter (D) distribution measurement, and D₅₀ is equal to a D₅₀ filament diameter (D) distribution measurement. According to certain embodiments, the batch of porous adsorbent filaments may have a diameter (D) distribution span PDDS of not greater than about 50%, such as, not greater than about 49% or not greater than about 48% or not greater than about 47% or not greater than about 46% or not greater than about 45% or not greater than about 44% or not greater than about 43% or not greater than about 42% or not greater than about 41% or even not greater than about 40%. It will be appreciated that the diameter (D) distribution span PDDS of the batch of porous adsorbent filaments may be any value between, and including, any of the minimum and maximum values noted above. It will be further appreciated that the diameter (D) distribution span PDDS of the batch of porous adsorbent filaments may be within a range between, and including, any of the minimum and maximum values noted above.

According to still other embodiments, the batch of porous adsorbent filaments may have a particular aspect ratio (AR) distribution span PARDS, where PARDS is equal to (AR₉₀−AR₁₀)/AR₅₀, where AR₉₀ is equal to a AR₉₀ filament aspect ratio (AR) distribution measurement of the batch of porous adsorbent filaments, AR₁₀ is equal to a AR₁₀ filament aspect ratio (AR) distribution measurement, and AR₅₀ is equal to a AR₅₀ filament aspect ratio (AR) distribution measurement. According to certain embodiments, the batch of porous adsorbent filaments may have an aspect ratio (AR) distribution span PARDS of not greater than about 50%, such as, not greater than about 49% or not greater than about 48% or not greater than about 47% or not greater than about 46% or not greater than about 45% or not greater than about 44% or not greater than about 43% or not greater than about 42% or not greater than about 41% or even not greater than about 40%. It will be appreciated that the aspect ratio (AR) distribution span PARDS of the batch of porous adsorbent filaments may be any value between, and including, any of the minimum and maximum values noted above. It will be further appreciated that the aspect ratio (AR) distribution span PARDS of the batch of porous adsorbent filaments may be within a range between, and including, any of the minimum and maximum values noted above.

According to yet other embodiments, the batch of porous adsorbent filaments may have a particular average filament cross-sectional diameter (D). According to certain embodiments, the batch of porous adsorbent filaments may have an average cross-sectional diameter of not greater than about 5 mm, such as, not greater than about 4.5 mm or not greater than about 4.0 mm or not greater than about 3.5 mm or not greater than about 3.0 mm or even not greater than about 2.0 mm. According to still other embodiments, the batch of porous adsorbent filaments may have an average cross-sectional diameter of at least about 0.01 mm or at least about 0.05 mm or at least about 0.1 mm or at least about 0.5 mm or at least about 1.0 mm or at least about 1.5 mm or even at least about 2.0 mm. It will be appreciated that the average cross-sectional diameter of the batch of porous adsorbent filaments may be any value between, and including, any of the minimum and maximum values noted above. It will be further appreciated that the average cross-sectional diameter of the batch of porous adsorbent filaments may be within a range between, and including, any of the minimum and maximum values noted above.

According to still other embodiments, the batch of porous adsorbent filaments may have a particular average length (L). According to certain embodiments, the batch of porous adsorbent filaments may have an average filament length of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or not greater than about 6.0 mm or not greater than about 5.5 mm or even not greater than about 5.0 mm. According to yet other embodiments, the batch of porous adsorbent filaments may have an average filament length of at least about 0.01 mm, such as, at least about 0.05 mm or at least about 0.1 mm or at least about 0.5 mm or at least about 1.0 mm or at least about 1.5 mm or even at least about 2.0 mm. It will be appreciated that the average length of the batch of porous adsorbent filaments may be any value between, and including, any of the minimum and maximum values noted above. It will be further appreciated that the average length of the batch of porous adsorbent filaments may be within a range between, and including, any of the minimum and maximum values noted above.

According to yet other embodiments, the batch of porous adsorbent filaments may have a particular average aspect ratio (AR). According to certain embodiments, the batch of porous adsorbent filaments may have an average aspect ratio (AR) of not greater than about 20, such as, not greater than about 19 or not greater than about 18 or not greater than about 17 or not greater than about 16 or not greater than about 15 or not greater than about 14 or not greater than about 13 or not greater than about 12 or not greater than about 11 or even not greater than about 10. According to still other embodiments, the batch of porous adsorbent filaments may have an average aspect ratio (AR) of at least about 0.5, such as, at least about 1 or at least about 2 or at least about 3 or at least about 4 or at least about 5 or at least about 6 or even at least about 7. It will be appreciated that the average aspect ratio (AR) of the batch of porous adsorbent filaments may be any value between, and including, any of the minimum and maximum values noted above. It will be further appreciated that the average aspect ratio (AR) of the batch of porous adsorbent filaments may be within a range between, and including, any of the minimum and maximum values noted above.

According to yet other embodiments, the batch of porous adsorbent filaments may have a particular packing density. For purposes of embodiments described herein, packing density is measured using a 100 mL graduated cylinder, which is weighed and then filled to the 100 mL level with a sample of the batch of porous adsorbent filaments. An AT-2 Autotap Tap Density Analyzer (manufactured by Quantachrome Instruments located in Boynton Beach, FL, USA) is set to perform 1000 taps and tapping is initiated. After completion of 1000 taps, the volume of the sample is measured to the nearest 0.5 mL. The sample and graduated cylinder are then weighed and the mass of the empty graduated cylinder is subtracted to yield the mass of the sample, which is then divided by the volume of the sample to obtain the packing density.

According to certain embodiments, the batch of porous adsorbent filaments may have a packing density of at least about 0.6 g/cm³, such as, at least about 0.62 g/cm³ or at least about 0.64 g/cm³ or at least about 0.66 g/cm³ or at least about 0.68 g/cm³ or at least about 0.70 g/cm³ or even at least about 0.72 g/cm³. According to still other embodiments, the batch of porous adsorbent filaments may have a packing density of not greater than about 1.5 g/cm³, such as, not greater than about 1.40 g/cm³ or not greater than about 1.30 g/cm³ or not greater than about 1.20 g/cm³ or not greater than about 1.10 g/cm³ or not greater than about 1.0 g/cm³ or not greater than about 0.98 g/cm³ or not greater than about 0.96 g/cm³ or not greater than about 0.94 g/cm³ or not greater than about 0.92 g/cm³ or not greater than about 0.90 g/cm³ or not greater than about 0.88 g/cm³ or not greater than about 0.86 g/cm³ or not greater than about 0.84 g/cm³ or even not greater than about 0.82 g/cm³. It will be appreciated that the packing density of the batch of porous adsorbent filaments may be any value between, and including, any of the minimum and maximum values noted above. It will be further appreciated that the packing density of the batch of porous adsorbent filaments may be within a range between, and including, any of the minimum and maximum values noted above.

According to yet other embodiments, the batch of porous adsorbent filaments may have a particular envelope density. For purposes of embodiments described herein, envelope density is measured using a Micromeritics Geo-Pycnometer 1360 instrument. This instrument determines density by measuring the change in volume when a sample of known mass is introduced into a chamber containing Micromeritics DryFlo™. DryFlo consists of small ceramic beads coated in graphite powder. A calibration is first performed with only DryFlo present in the cylindrical sample chamber. The contents of the chamber are pressed by a plunger to a maximum force of 90 N, and the distance that the plunger is pressed to achieve this force is recorded by the instrument. From this distance measurement, the volume of the DryFlo within the sample chamber is calculated by the instrument. This cycle is repeated five times for the calibration, and the average volume is obtained. The chamber and plunger are then removed and a sample of the batch of porous adsorbent filaments of known mass (about 2.5 grams) is added to the DryFlo in the chamber. The measured mass is input into the instrument. The process of pressing the plunger to a maximum force of 90 N is then repeated for five cycles with the sample present in the chamber. The instrument calculates the average volume of the DryFlo-sample mixture from the distance that the plunger was pressed for each cycle. By subtracting the average volume for the DryFlo calibration from the average volume for the DryFlo-sample run, the volume of the sample is obtained. With the mass of the sample known, the instrument outputs the density of the sample by dividing mass by volume.

According to yet other embodiments, the batch of porous adsorbent filaments may have an envelope density of at least about 0.9 g/cm³, such as, at least about 0.92 g/cm³ or at least about 0.94 g/cm³ or at least about 0.96 g/cm³ or at least about 0.98 g/cm³ or at least about 1.0 g/cm³ or even at least about 1.02 g/cm³. According to still other embodiments, the batch of porous adsorbent filaments may have an envelope density of not greater than about 2.0 g/cm³, such as, not greater than about 1.9 g/cm³ or not greater than about 1.8 g/cm³ or not greater than about 1.7 g/cm³ or not greater than about 1.6 g/cm³ or not greater than about 1.5 g/cm³ or not greater than about 1.4 g/cm³ or not greater than about 1.3 g/cm³ or not greater than about 1.28 g/cm³ or not greater than about 1.26 g/cm³ or not greater than about 1.24 g/cm³ or even not greater than about 1.22 g/cm³. It will be appreciated that the envelope density of the batch of porous adsorbent filaments may be any value between, and including, any of the minimum and maximum values noted above. It will be further appreciated that the envelope density of the batch of porous adsorbent filaments may be within a range between, and including, any of the minimum and maximum values noted above.

According to yet other embodiments, the batch of porous adsorbent filaments may have a particular void volume. For purposes of embodiments described herein, the void volume is a percentage within a sample of the batch of porous adsorbent filaments calculated by subtracting the packing density from the envelope density, and then by dividing this difference by the envelope density.

According to particular embodiments, the batch of porous adsorbent filaments may have a void volume of at least about 5%, such as, at least about 10% or at least about 18% or at least about 20% or at least about 23% or even at least about 25%. According to still other embodiments, the batch of porous adsorbent filaments may have a void volume of not greater than about 45%, such as, not greater than about 42% or not greater than about 40% or not greater than about 37% or even not greater than about 35%. It will be appreciated that the void volume of the batch of porous adsorbent filaments may be any value between, and including, any of the minimum and maximum values noted above. It will be further appreciated that the void volume of the batch of porous adsorbent filaments may be within a range between, and including, any of the minimum and maximum values noted above.

According to certain embodiments, the porous adsorbent filaments of the batch of porous adsorbent filaments may be porous solid particulate materials. According to yet other embodiments, the porous adsorbent filaments of the batch of porous adsorbent filaments may be porous solid particulate materials configured for uptake and immobilization of a species from a surrounding medium by one or more adsorption processes. According to yet other embodiments, the porous adsorbent filaments of the batch of porous adsorbent filaments may be further configured for desorption of the species from the surrounding medium subsequent to uptake and immobilization of the species.

According to still other embodiments, the porous adsorbent filaments may not be configured for use as abrasive filaments. According to other embodiments, the porous adsorbent filaments may not be abrasive filaments.

According to yet other embodiments, the porous adsorbent filaments may not be configured for use in material removal through a grinding operation. According to yet other embodiments, the porous adsorbent filaments may not be configured for use in material removal through a grinding operation of a workpiece having a particular Vickers hardness. For example, the porous adsorbent filaments may not be configured for use in material removal through a grinding operation of a workpiece having a Vickers hardness of at least about 5 GPa, such as, at least about 10 GPa or even at least about 15 GPa. It will be appreciated that the workpiece Vickers hardness may be any value between, and including, any of the minimum and maximum values noted above. It will be further appreciated that the workpiece Vickers hardness may be within a range between, and including, any of the minimum and maximum values noted above.

According to yet other embodiments, the porous adsorbent filaments may have a Mohs hardness that is not greater than a Mohs hardness of abrasive filaments. According to certain embodiments, the porous adsorbent filaments have a particular Mohs hardness. For example, the Mohs hardness of the porous adsorbent filaments may be not greater than about 5, such as, not greater than about 4 or not greater than about 3 or not greater than about 2 or even not greater than about 1. It will be appreciated that the Mohs hardness of the porous adsorbent filaments may be any value between, and including, any of the minimum and maximum values noted above. It will be further appreciated that the Mohs hardness of the porous adsorbent filaments may be within a range between, and including, any of the minimum and maximum values noted above.

According to yet other embodiments, the porous adsorbent filaments may have a Vickers hardness that is not greater than a Vickers hardness of abrasive filaments. According to certain embodiments, the porous adsorbent filaments have a particular Vickers hardness. For example, the Vickers hardness of the porous adsorbent filaments may be not greater than about 15, such as, not greater than about 10 or even not greater than about 5. It will be appreciated that the Vickers hardness of the porous adsorbent filaments may be any value between, and including, any of the minimum and maximum values noted above. It will be further appreciated that the Vickers hardness of the porous adsorbent filaments may be within a range between, and including, any of the minimum and maximum values noted above.

It will be appreciated that embodiments described herein may, in particular, be directed to the formation of a batch of shaped lithium bayerite adsorbent filaments having generally uniform shape throughout the batch.

For purposes of embodiments described herein, adsorbent filaments for lithium adsorption (e.g. lithium bayerite adsorbent filaments) are defined as adsorbent filaments configured for, useful for, or directly applied for the adsorption of lithium-containing species (e.g. a solid, a liquid, a gas, a molecule, an atom, or an ion) from a surrounding medium (e.g. a solid, a liquid, or a gas) by one or more adsorption processes including physisorption, chemisorption, and intercalation and ion exchange. The adsorbed lithium based compound may be subsequently removed or desorbed allowing as a consequence the adsorbent to be reused and advantageously the adsorbed components to be recovered (and concentrated).

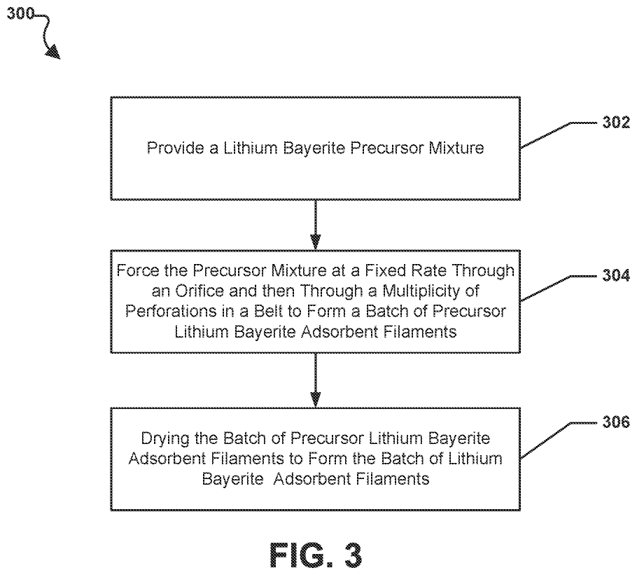

Referring to a method of forming a batch of shaped lithium bayerite adsorbent filaments, FIG. 3 illustrates a porous adsorbent filament forming process generally designated 100. Shaped lithium bayerite adsorbent filaments forming process 100 may include a first step 102 of providing a lithium bayerite precursor mixture, a second step 104 of forcing the lithium bayerite precursor mixture at a fixed rate through an orifice and then through a multiplicity of perforations in a belt, where the belt moves across and in tight registry with said orifice to form a batch of precursor shaped lithium bayerite adsorbent filaments, and a third step 106 of drying the batch of precursor shaped lithium bayerite adsorbent filaments to form the batch of porous adsorbent filaments.

Referring now to the lithium bayerite precursor mixture according to certain embodiments, the lithium bayerite precursor mixture may include any combination of materials necessary for forming a shaped lithium bayerite adsorbent filament.

Referring now to the batch of lithium bayerite adsorbent filaments, according to certain embodiments, the batch of lithium bayerite adsorbent filaments may include a lithium aluminate. According to still other embodiments, the batch of lithium bayerite adsorbent filaments formed according to the forming process 300 described herein may include a 2-layer lithium aluminate. According to yet other embodiments, the batch of lithium bayerite adsorbent filaments may include lithium bayerite. According to still other particular embodiments, the batch of lithium bayerite adsorbent filaments formed according to the forming process 300 described herein may include a solid material of the formula (LiCl)ₓ·2Al(OH)₃,nH₂O, with n being between 0.01 and 10, preferably between 0.1 and 5, and preferably between 0.1 and 1.

According to still other embodiments, the batch of shaped lithium bayerite adsorbent filaments may have particular moisture content measured as described herein. According to particular embodiments, the batch of shaped lithium bayerite adsorbent filaments may have a moisture content of at least about 20 wt. % based on a total weight of the batch of adsorbent filaments, such as, at least about 21 wt. % or at least about 22 wt. % or at least about 23 wt. % or at least about 24 wt. % or at least about 25 wt. % or at least about 26 wt. % or at least about 27 wt. % or at least about 28 wt. % or at least about 29 wt. % or at least about 30 wt. % or at least about 31 wt. % or at least about 32 wt. % or at least about 33 wt. % or at least about 34 wt. % or at least about 35 wt. % or at least about 36 wt. % or at least about 37 wt. % or at least about 38 wt. % or at least about 39 wt. % or at least about 40 wt. % or at least about 41 wt. % or at least about 42 wt. % or at least about 43 wt. % or at least about 44 wt. % or even at least about 45 wt. %. According to still other embodiments, the batch of shaped lithium bayerite adsorbent filaments may have a moisture content of not greater than about 60 wt. % based on a total weight of the batch of adsorbent filaments, such as, not greater than about 58 wt. % or not greater than about 56 wt. % or not greater than about 54 wt. % or not greater than about 52 wt. % or not greater than about 50 wt. %. It will be appreciated that the moisture content of the batch of shaped lithium bayerite adsorbent filaments may be any value between, and including, any of the minimum and maximum values noted above. It will be further appreciated that the moisture content of the batch of shaped lithium bayerite adsorbent filaments may be within a range between, and including, any of the minimum and maximum values noted above.

According to yet other embodiments, the batch of shaped lithium bayerite adsorbent filaments may include a plurality of filaments having a columnar shape. According to still other embodiments, the plurality of filament may have a circular cross-sectional shape. According to yet other embodiments, the plurality of filaments may have an oval cross-sectional shape. According to still other embodiments, the plurality of filaments may have a polygonal cross-sectional shape.

According to still other embodiments, the filaments in the batch of shaped lithium bayerite adsorbent filaments, which has a columnar shape, may have basic dimensions including length (L), cross-sectional diameter (D), and aspect ratio (AR). For purposes of embodiments described herein, the length (L) of a filament is defined as the greatest dimension perpendicular to the cross-sectional shape of the filament. The cross-sectional diameter (D) is the greatest dimension of the cross-sectional shape of the filament. The aspect ratio (AR) of filaments in the batch of shaped lithium bayerite adsorbent filaments is equal to the length (L) of a filament in the batch of shaped lithium bayerite adsorbent filaments divided by the cross-sectional diameter (D) of the filament in the batch of shaped lithium bayerite adsorbent filaments. It will be further appreciated that all measurements, including average length (L), average cross-sectional diameter (i.e., equivalent diameter) (D), and average particle aspect ratio (AR), of a particular batch of shaped lithium bayerite adsorbent filaments are measured using images collected with an Olympus DSX510 digital optical microscope. Filaments of a sample batch are placed on the microscope stage and distributed in a monolayer. The height of the lens is adjusted to bring the filament boundaries into focus. The “Live Panorama” tool is used to stitch together a 9 frame by 9 frame image. Measurements of length and diameter are made for at least 20 filaments from the image using the “Measure” tool within the Olympus software. Aspect ratio (AR) of a given filament is calculated by dividing the length by diameter (L/D).

According to still other embodiments, the batch of shaped lithium bayerite adsorbent filaments may have a particular length (L) distribution span PLDS, where PLDS is equal to (L₉₀−L₁₀)/L₅₀, where Loo is equal to a L₉₀ filament length (L) distribution measurement of the batch of shaped lithium bayerite adsorbent filaments, L₁₀ is equal to a L₁₀ filament length (L) distribution measurement, and L₅₀ is equal to a L₅₀ filament length (L) distribution measurement. According to certain embodiments, the batch of shaped lithium bayerite adsorbent filaments may have a length (L) distribution span PLDS of not greater than about 50%, such as, not greater than about 49% or not greater than about 48% or not greater than about 47% or not greater than about 46% or not greater than about 45% or not greater than about 44% or not greater than about 43% or not greater than about 42% or not greater than about 41% or even not greater than about 40%. It will be appreciated that the length (L) distribution span PLDS of the batch of shaped lithium bayerite adsorbent filaments may be any value between, and including, any of the minimum and maximum values noted above. It will be further appreciated that the length (L) distribution span PLDS of the batch of shaped lithium bayerite adsorbent filaments may be within a range between, and including, any of the minimum and maximum values noted above.

According to still other embodiments, the batch of shaped lithium bayerite adsorbent filaments may have a particular diameter (D) distribution span PDDS, where PDDS is equal to (D₉₀−D₁₀)/D₅₀, where D₉₀ is equal to a D₉₀ filament diameter (D) distribution measurement of the batch of shaped lithium bayerite adsorbent filaments, D₁₀ is equal to a D₁₀ filament diameter (D) distribution measurement, D₅₀ is equal to a D₅₀ filament diameter (D) distribution measurement. According to certain embodiments, the batch of shaped lithium bayerite adsorbent filaments may have a diameter (D) distribution span PDDS of not greater than about 50%, such as, not greater than about 49% or not greater than about 48% or not greater than about 47% or not greater than about 46% or not greater than about 45% or not greater than about 44% or not greater than about 43% or not greater than about 42% or not greater than about 41% or even not greater than about 40%. It will be appreciated that the diameter (D) distribution span PDDS of the batch of shaped lithium bayerite adsorbent filaments may be any value between, and including, any of the minimum and maximum values noted above. It will be further appreciated that the diameter (D) distribution span PDDS of the batch of shaped lithium bayerite adsorbent filaments may be within a range between, and including, any of the minimum and maximum values noted above.

According to still other embodiments, the batch of shaped lithium bayerite adsorbent filaments may have a particular aspect ratio (AR) distribution span PARDS, where PARDS is equal to (AR₉₀−AR₁₀)/AR₅₀, where AR₉₀ is equal to a AR₉₀ filament aspect ratio (AR) distribution measurement of the batch of shaped lithium bayerite adsorbent filaments, AR₁₀ is equal to a AR₁₀ filament aspect ratio (AR) distribution measurement, AR₅₀ is equal to a AR₅₀ filament aspect ratio (AR) distribution measurement. According to certain embodiments, the batch of shaped lithium bayerite adsorbent filaments may have an aspect ratio (AR) distribution span PARDS of not greater than about 50%, such as, not greater than about 49% or not greater than about 48% or not greater than about 47% or not greater than about 46% or not greater than about 45% or not greater than about 44% or not greater than about 43% or not greater than about 42% or not greater than about 41% or even not greater than about 40%. It will be appreciated that the aspect ratio (AR) distribution span PARDS of the batch of shaped lithium bayerite adsorbent filaments may be any value between, and including, any of the minimum and maximum values noted above. It will be further appreciated that the aspect ratio (AR) distribution span PARDS of the batch of shaped lithium bayerite adsorbent filaments may be within a range between, and including, any of the minimum and maximum values noted above.

According to yet other embodiments, the batch of shaped lithium bayerite adsorbent filaments may have a particular average filament cross-sectional diameter (D). According to certain embodiments, the batch of shaped lithium bayerite adsorbent filaments may have an average cross-sectional diameter of not greater than about 5 mm, such as, not greater than about 4.5 mm or not greater than about 4.0 mm or not greater than about 3.5 mm or not greater than about 3.0 mm or even not greater than about 2.0 mm. According to still other embodiments, the batch of shaped lithium bayerite adsorbent filaments may have an average cross-sectional diameter of at least about 0.01 mm or at least about 0.05 mm or at least about 0.1 mm or at least about 0.5 mm or at least about 1.0 mm or at least about 1.5 mm or even at least about 2.0 mm. It will be appreciated that the average cross-sectional diameter of the batch of shaped lithium bayerite adsorbent filaments may be any value between, and including, any of the minimum and maximum values noted above. It will be further appreciated that the average cross-sectional diameter of the batch of shaped lithium bayerite adsorbent filaments may be within a range between, and including, any of the minimum and maximum values noted above.

According to still other embodiments, the batch of shaped lithium bayerite adsorbent filaments may have a particular average length (L). According to certain embodiments, the batch of shaped lithium bayerite adsorbent filaments may have an average filament length of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or not greater than about 6.0 mm or not greater than about 5.5 mm or even not greater than about 5.0 mm. According to yet other embodiments, the batch of shaped lithium bayerite adsorbent filaments may have an average filament length of at least about 0.01 mm, such as, at least about 0.05 mm or at least about 0.1 mm or at least about 0.5 mm or at least about 1.0 mm or at least about 1.5 mm or even at least about 2.0 mm. It will be appreciated that the average length of the batch of shaped lithium bayerite adsorbent filaments may be any value between, and including, any of the minimum and maximum values noted above. It will be further appreciated that the average length of the batch of shaped lithium bayerite adsorbent filaments may be within a range between, and including, any of the minimum and maximum values noted above.

According to yet other embodiments, the batch of shaped lithium bayerite adsorbent filaments may have a particular average aspect ratio (AR). According to certain embodiments, the batch of shaped lithium bayerite adsorbent filaments may have an average aspect ratio (AR) of not greater than about 20, such as, not greater than about 19 or not greater than about 18 or not greater than about 17 or not greater than about 16 or not greater than about 15 or not greater than about 14 or not greater than about 13 or not greater than about 12 or not greater than about 11 or even not greater than about 10. According to still other embodiments, the batch of shaped lithium bayerite adsorbent filaments may have an average aspect ratio (AR) of at least about 0.5, such as, at least about 1 or at least about 2 or at least about 3 or at least about 4 or at least about 5 or at least about 6 or even at least about 7. It will be appreciated that the average aspect ratio (AR) of the batch of shaped lithium bayerite adsorbent filaments may be any value between, and including, any of the minimum and maximum values noted above. It will be further appreciated that the average aspect ratio (AR) of the batch of shaped lithium bayerite adsorbent filaments may be within a range between, and including, any of the minimum and maximum values noted above.

According to yet other embodiments, the batch of shaped lithium bayerite adsorbent filaments may have a particular packing density measured as described herein. According to certain embodiments, the batch of shaped lithium bayerite adsorbent filaments may have a packing density of at least about 0.6 g/cm³, such as, at least about 0.62 g/cm³ or at least about 0.64 g/cm³ or at least about 0.66 g/cm³ or at least about 0.68 g/cm³ or at least about 0.70 g/cm³ or even at least about 0.72 g/cm³. According to still other embodiments, the batch of shaped lithium bayerite adsorbent filaments may have a packing density of not greater than about 1.5 g/cm³, such as, not greater than about 1.40 g/cm³ or not greater than about 1.30 g/cm³ or not greater than about 1.20 g/cm³ or not greater than about 1.10 g/cm³ or not greater than about 1.0 g/cm³ or not greater than about 0.98 g/cm³ or not greater than about 0.96 g/cm³ or not greater than about 0.94 g/cm³ or not greater than about 0.92 g/cm³ or not greater than about 0.90 g/cm³ or not greater than about 0.88 g/cm³ or not greater than about 0.86 g/cm³ or not greater than about 0.84 g/cm³ or even not greater than about 0.82 g/cm³. It will be appreciated that the packing density of the batch of shaped lithium bayerite adsorbent filaments may be any value between, and including, any of the minimum and maximum values noted above. It will be further appreciated that the packing density of the batch of shaped lithium bayerite adsorbent filaments may be within a range between, and including, any of the minimum and maximum values noted above.

According to yet other embodiments, the batch of shaped lithium bayerite adsorbent filaments may have a particular envelope density measured as described herein. According to yet other embodiments, the batch of shaped lithium bayerite adsorbent filaments may have an envelope density of at least about 0.9 g/cm³, such as, at least about 0.92 g/cm³ or at least about 0.94 g/cm³ or at least about 0.96 g/cm³ or at least about 0.98 g/cm³ or at least about 1.0 g/cm³ or even at least about 1.02 g/cm³. According to still other embodiments, the batch of shaped lithium bayerite adsorbent filaments may have an envelope density of not greater than about 2.0 g/cm³, such as, not greater than about 1.9 g/cm³ or not greater than about 1.8 g/cm³ or not greater than about 1.7 g/cm³ or not greater than about 1.6 g/cm³ or not greater than about 1.5 g/cm³ or not greater than about 1.4 g/cm³ or not greater than about 1.3 g/cm³ or not greater than about 1.28 g/cm³ or not greater than about 1.26 g/cm³ or not greater than about 1.24 g/cm³ or even not greater than about 1.22 g/cm³. It will be appreciated that the envelope density of the batch of shaped lithium bayerite adsorbent filaments may be any value between, and including, any of the minimum and maximum values noted above. It will be further appreciated that the envelope density of the batch of shaped lithium bayerite adsorbent filaments may be within a range between, and including, any of the minimum and maximum values noted above.

According to yet other embodiments, the batch of shaped lithium bayerite adsorbent filaments may have a particular void volume calculated as described herein. According to particular embodiments, the batch of shaped lithium bayerite adsorbent filaments may have a void volume of at least about 5%, such as, at least about 10% or at least about 18% or at least about 20% or at least about 23% or even at least about 25%. According to still other embodiments, the batch of shaped lithium bayerite adsorbent filaments may have a void volume of not greater than about 45%, such as, not greater than about 42% or not greater than about 40% or not greater than about 37% or even not greater than about 35%. It will be appreciated that the void volume of the batch of shaped lithium bayerite adsorbent filaments may be any value between, and including, any of the minimum and maximum values noted above. It will be further appreciated that the void volume of the batch of shaped lithium bayerite adsorbent filaments may be within a range between, and including, any of the minimum and maximum values noted above.

According to certain embodiments, the shaped lithium bayerite adsorbent filaments may be porous solid particulate materials. According to yet other embodiments, the shaped lithium bayerite adsorbent filaments may be porous solid particulate materials configured for uptake and immobilization of a lithium-containing species from a surrounding medium by one or more adsorption processes. According to yet other embodiments, the shaped lithium bayerite adsorbent filaments may be further configured for desorption of the lithium-containing species from the surrounding medium subsequent to uptake and immobilization of the species.

According to still other embodiments, the shaped lithium bayerite adsorbent filaments may not be configured for use as abrasive filaments. According to other embodiments, the shaped lithium bayerite adsorbent filaments may not be abrasive filaments.

According to yet other embodiments, the shaped lithium bayerite adsorbent filaments may not be configured for use in material removal through a grinding operation. According to yet other embodiments, the shaped lithium bayerite adsorbent filaments may not be configured for use in material removal through a grinding operation of a workpiece having a particular Vickers hardness. For example, the shaped lithium bayerite adsorbent filaments may not be configured for use in material removal through a grinding operation of a workpiece having a Vickers hardness of at least about 5 GPa, such as, at least about 10 GPa or even at least about 15 GPa. It will be appreciated that the workpiece Vickers hardness may be any value between, and including, any of the minimum and maximum values noted above. It will be further appreciated that the workpiece Vickers hardness may be within a range between, and including, any of the minimum and maximum values noted above.

According to yet other embodiments, the shaped lithium bayerite adsorbent filaments may have a Mohs hardness that is not greater than a Mohs hardness of abrasive filaments. According to certain embodiments, the shaped lithium bayerite adsorbent filaments have a particular Mohs hardness. For example, the Mohs hardness of the shaped lithium bayerite adsorbent filaments may be not greater than about 5, such as, not greater than about 4 or not greater than about 3 or not greater than about 2 or even not greater than about 1. It will be appreciated that the Mohs hardness of the shaped lithium bayerite adsorbent filaments may be any value between, and including, any of the minimum and maximum values noted above. It will be further appreciated that the Mohs hardness of the shaped lithium bayerite adsorbent filaments may be within a range between, and including, any of the minimum and maximum values noted above.

According to yet other embodiments, the shaped lithium bayerite adsorbent filaments may have a Vickers hardness that is not greater than a Vickers hardness of abrasive filaments. According to certain embodiments, the shaped lithium bayerite adsorbent filaments have a particular Vickers hardness. For example, the Vickers hardness of the shaped lithium bayerite adsorbent filaments may be not greater than about 15, such as, not greater than about 10 or even not greater than about 5. It will be appreciated that the Vickers hardness of the shaped lithium bayerite adsorbent filaments may be any value between, and including, any of the minimum and maximum values noted above. It will be further appreciated that the Vickers hardness of the shaped lithium bayerite adsorbent filaments may be within a range between, and including, any of the minimum and maximum values noted above.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A method of forming a batch of porous adsorbent filaments, wherein the method comprises: providing a precursor mixture, forcing the precursor mixture at a fixed rate through an orifice and then through a multiplicity of perforations in a belt, wherein the belt moves across and in tight registry with said orifice to form a batch of precursor porous adsorbent filaments, and drying the batch of precursor porous adsorbent filaments to form the batch of porous adsorbent filaments, wherein the batch of porous adsorbent filaments comprises a moisture content of at least about 20 wt. %.

Embodiment 2. The method of embodiment 1, wherein the precursor mixture comprises ceramic components, such as, aluminas, boehmites, bayerites, aluminum hydroxides, silicas, titanias, zirconias, and combinations thereof, metal components, such as, transition metals including Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, Au, Rf, Db, Sg, Bh, Hs (i.e., transition metals contained in groups 3-11 of the periodic table) and combinations thereof, alkali and alkaline earth metal components, such as, Li, Be, Na, Mg, K, Ca, Rb, Sr, Cs, Ba, and combinations thereof; carbon, metal organic framework (MOF) or combinations thereof.

Embodiment 3. The method of embodiment 1, wherein the batch of porous adsorbent filaments comprises a lithium aluminate, wherein the batch of porous adsorbent filaments comprises a 2-layer lithium aluminate, wherein the batch of porous adsorbent filaments comprises (LiCl)ₓ·2Al(OH)₃,nH₂O, wherein the batch of porous adsorbent filaments comprises lithium bayerite.

Embodiment 4. The method of embodiment 1, wherein the batch of porous adsorbent filaments comprises a moisture content of at least about 20 wt. % based on a total weight of the batch of porous adsorbent filaments, such as, at least about 21 wt. % or at least about 22 wt. % or at least about 23 wt. % or at least about 24 wt. % or at least about 25 wt. % or at least about 26 wt. % or at least about 27 wt. % or at least about 28 wt. % or at least about 29 wt. % or at least about 30 wt. % or at least about 31 wt. % or at least about 32 wt. % or at least about 33 wt. % or at least about 34 wt. % or at least about 35 wt. % or at least about 36 wt. % or at least about 37 wt. % or at least about 38 wt. % or at least about 39 wt. % or at least about 40 wt. % or at least about 41 wt. % or at least about 42 wt. % or at least about 43 wt. % or at least about 44 wt. % or at least about 45 wt. %.

Embodiment 5. The method of embodiment 1, wherein the batch of porous adsorbent filaments comprises a moisture content of not greater than about 60 wt. % based on a total weight of the batch of porous adsorbent filaments or not greater than about 58 wt. % or not greater than about 56 wt. % or not greater than about 54 wt. % or not greater than about 52 wt. % or not greater than about 50 wt. %.

Embodiment 6. The method of embodiment 1, wherein the batch of porous adsorbent filaments comprises an envelope density of at least about 0.9 g/cm³.

Embodiment 7. The method of embodiment 1, wherein the batch of porous adsorbent filaments comprises an envelope density of not greater than about 2.0 g/cm³.

Embodiment 8. The method of embodiment 1, wherein the batch of porous adsorbent filaments comprises a plurality of filaments having a columnar shape.

Embodiment 9. The method of embodiment 1, wherein the batch of porous adsorbent filaments comprises a plurality of filaments having a circular cross-sectional shape.

Embodiment 10. The method of embodiment 1, wherein the batch of porous adsorbent filaments comprises a plurality of filaments having an oval cross-sectional shape.

Embodiment 11. The method of embodiment 1, wherein the batch of porous adsorbent filaments comprises a plurality of filaments having a polygonal cross-sectional shape.

Embodiment 12. The method of embodiment 1, wherein the batch of porous adsorbent filaments has an average filament diameter of not greater than about 5 mm and a filament aspect ratio (L/D) distribution span PARDS of not greater than about 50%, where PARDS is equal to (AR90−AR10)/AR50, where AR90 is equal to a AR90 filament aspect ratio (L/D) distribution measurement of the batch of porous adsorbent filaments, AR10 is equal to a AR10 filament aspect ratio (L/D) distribution measurement, and AR50 is equal to a AR50 filament aspect ratio (L/D) distribution measurement.

Embodiment 13. The method of embodiment 1, wherein the batch of porous adsorbent filaments has an average filament diameter of not greater than about 5 mm.

Embodiment 14. The method of embodiment 1, wherein the batch of porous adsorbent filaments has an average filament diameter of at least about 0.01 mm.

Embodiment 15. The method of embodiment 1, wherein the batch of porous adsorbent filaments has an average filament length of at least about 0.01 mm.

Embodiment 16. The method of embodiment 1, wherein the batch of porous adsorbent filaments has an average filament length of not greater than about 10 mm.

Embodiment 17. The method of embodiment 1, wherein the batch of porous adsorbent filaments have an average aspect ratio (L/D) of not greater than about 20.

Embodiment 18. The method of embodiment 1, wherein the batch of porous adsorbent filaments has an average aspect ratio (L/D) of at least about 0.5.

Embodiment 19. The method of embodiment 1, wherein the porous adsorbent filaments of the batch of porous adsorbent filaments are porous solid filaments configured for uptake and immobilization of a species from a surrounding medium by one or more adsorption processes.

Embodiment 20. The method of embodiment 1, wherein the porous adsorbent filaments of the batch of porous adsorbent filaments are further configured for desorption of the species from the surrounding medium subsequent to uptake and immobilization of the species.

Embodiment 21. The method of embodiment 1, wherein the porous adsorbent filaments are not configured for use as abrasive filaments.

Embodiment 22. The method of embodiment 1, wherein the porous adsorbent filaments are not abrasive filaments.

Embodiment 23. The method of embodiment 1, wherein the porous adsorbent filaments can not be configured for use in material removal through a grinding operation.

Embodiment 24. The method of embodiment 1, wherein the porous adsorbent filaments can not be configured for use in material removal through a grinding operation of a workpiece having a Vickers hardness of at least about 5 GPa, at least about 10 GPa, at least about 11 GPa.

Embodiment 25. The method of embodiment 1, wherein the porous adsorbent filaments have a hardness not greater than a hardness of abrasive filaments.

Embodiment 26. The method of embodiment 1, wherein the porous adsorbent filaments have a Mohs hardness that is not greater than a Mohs hardness of abrasive filaments.

Embodiment 27. The method of embodiment 1, wherein the porous adsorbent filaments have a Mohs hardness of not greater than about 7, not greater than about 6, not greater than about 5, not greater than about 4, not greater than about 3, not greater than about 2, not greater than about 1.

Embodiment 28. The method of embodiment 1, wherein the porous adsorbent filaments have a Vickers hardness that is not greater than a Vickers hardness of abrasive filaments.

Embodiment 29. The method of embodiment 1, wherein the porous adsorbent filaments have a Vickers hardness of not greater than about 11 GPa, not greater than about 10 GPa, not greater than about 5 GPa.

Embodiment 30. A batch of porous adsorbent filaments comprising an average aspect ratio (L/D) of at least about 0.5 and a wherein the batch of porous adsorbent filaments comprises a moisture content of at least about 20 wt. %.

Embodiment 31. The batch of porous adsorbent filaments of embodiment 30, wherein the batch of porous adsorbent filaments comprises a lithium aluminate, wherein the batch of porous adsorbent filaments comprises a 2-layer lithium aluminate, wherein the batch of porous adsorbent filaments comprises (LiCl)ₓ·2Al(OH)₃,nH₂O, wherein the batch of porous adsorbent filaments comprises Li Bayerite.

Embodiment 32. The batch of porous adsorbent filaments of embodiment 30, wherein the batch of porous adsorbent filaments comprises a moisture content of at least about 20 wt. % based on a total weight of the batch of porous adsorbent filaments, such as, at least about 21 wt. % or at least about 22 wt. % or at least about 23 wt. % or at least about 24 wt. % or at least about 25 wt. % or at least about 26 wt. % or at least about 27 wt. % or at least about 28 wt. % or at least about 29 wt. % or at least about 30 wt. % or at least about 31 wt. % or at least about 32 wt. % or at least about 33 wt. % or at least about 34 wt. % or at least about 35 wt. % or at least about 36 wt. % or at least about 37 wt. % or at least about 38 wt. % or at least about 39 wt. % or at least about 40 wt. % or at least about 41 wt. % or at least about 42 wt. % or at least about 43 wt. % or at least about 44 wt. % or at least about 45 wt. %.

Embodiment 33. The batch of porous adsorbent filaments of embodiment 30, wherein the batch of porous adsorbent filaments comprises a moisture content of not greater than about 60 wt. % based on a total weight of the batch of porous adsorbent filaments or not greater than about 58 wt. % or not greater than about 56 wt. % or not greater than about 54 wt. % or not greater than about 52 wt. % or not greater than about 50 wt. %.

Embodiment 34. The batch of porous adsorbent filaments of embodiment 30, wherein the batch of porous adsorbent filaments comprises an envelope density of at least about 0.9 g/cm³.

Embodiment 35. The batch of porous adsorbent filaments of embodiment 30, wherein the batch of porous adsorbent filaments comprises an envelope density of not greater than about 2.0 g/cm³.

Embodiment 36. The batch of porous adsorbent filaments of embodiment 30, wherein the batch of porous adsorbent filaments comprises a plurality of filaments having a columnar shape.

Embodiment 37. The batch of porous adsorbent filaments of embodiment 30, wherein the batch of porous adsorbent filaments comprises a plurality of filaments having a circular cross-sectional shape.

Embodiment 38. The batch of porous adsorbent filaments of embodiment 30, wherein the batch of porous adsorbent filaments comprises a plurality of filaments having an oval cross-sectional shape.

Embodiment 39. The batch of porous adsorbent filaments of embodiment 30, wherein the batch of porous adsorbent filaments comprises a plurality of filaments having a polygonal cross-sectional shape.

Embodiment 40. The batch of porous adsorbent filaments of embodiment 30, wherein the batch of porous adsorbent filaments has an average filament diameter of not greater than about 5 mm.

Embodiment 41. The batch of porous adsorbent filaments of embodiment 30, wherein the batch of porous adsorbent filaments has an average filament diameter of at least about 0.01 mm.

Embodiment 42. The batch of porous adsorbent filaments of embodiment 30, wherein the batch of porous adsorbent filaments has an average filament length of at least about 0.01 mm.

Embodiment 43. The batch of porous adsorbent filaments of embodiment 30, wherein the batch of porous adsorbent filaments has an average filament length of not greater than about 10 mm.

Embodiment 44. The batch of porous adsorbent filaments of embodiment 30, wherein the batch of porous adsorbent filaments has an average aspect ratio (L/D) of not greater than about 20.

Embodiment 45. The batch of porous adsorbent filaments of embodiment 30, wherein the batch of porous adsorbent filaments has an average aspect ratio (L/D) of at least about 0.5.

Embodiment 46. The batch of porous adsorbent filaments of embodiment 30, wherein the porous adsorbent filaments of the batch of porous adsorbent filaments are porous solid filaments configured for uptake and immobilization of a species from a surrounding medium by one or more adsorption processes.

Embodiment 47. The batch of porous adsorbent filaments of embodiment 30, wherein the porous adsorbent filaments of the batch of porous adsorbent filaments are further configured for desorption of the species from the surrounding medium subsequent to uptake and immobilization of the species.

Embodiment 48. The batch of porous adsorbent filaments of embodiment 30, wherein the porous adsorbent filaments are not configured for use as abrasive filaments.

Embodiment 49. The batch of porous adsorbent filaments of embodiment 30, wherein the porous adsorbent filaments are not abrasive filaments.

Embodiment 50. The batch of porous adsorbent filaments of embodiment 30, wherein the porous adsorbent filaments can not be configured for use in material removal through a grinding operation.

Embodiment 51. The batch of porous adsorbent filaments of embodiment 30, wherein the porous adsorbent filaments can not be configured for use in material removal through a grinding operation of a workpiece having a Vickers hardness of at least about 11 GPa, at least about 10 GPa, at least about 5 GPa.

Embodiment 52. The batch of porous adsorbent filaments of embodiment 30, wherein the porous adsorbent filaments have a hardness that is not greater than a hardness of abrasive filaments.

Embodiment 53. The batch of porous adsorbent filaments of embodiment 30, wherein the porous adsorbent filaments have a Mohs hardness that is not greater than a Mohs hardness of abrasive filaments.

Embodiment 54. The batch of porous adsorbent filaments of embodiment 30, wherein the porous adsorbent filaments have a Mohs hardness of not greater than about 7, not greater than about 6, not greater than about 5, not greater than about 4, not greater than about 3, not greater than about 2, not greater than about 1.

Embodiment 55. The batch of porous adsorbent filaments of embodiment 30, wherein the porous adsorbent filaments have a Vickers hardness that is not greater than a Vickers hardness of abrasive filaments.

Embodiment 56. The batch of porous adsorbent filaments of embodiment 30, wherein the porous adsorbent filaments have a Vickers hardness of not greater than about 11 GPa, not greater than about 10 GPa, not greater than about 5 GPa.

Embodiment 57. A system for forming a batch of porous adsorbent filaments, wherein the system comprises: an application zone comprising a shaping assembly including a reservoir configured to force a precursor mixture at a fixed rate through an orifice and then through a multiplicity of perforations in a belt, wherein the belt moves across and in tight registry with said orifice to form a batch of precursor porous adsorbent filaments, and a drying zone comprising a first heat source and being configured to dry the batch of precursor porous adsorbent filaments to form the batch of porous adsorbent filaments.

Embodiment 58. The system of embodiment 57, wherein the precursor mixture comprises ceramic components, such as, aluminas, boehmites, bayerites, aluminum hydroxides, silicas, titanias, zirconias, and combinations thereof, metal components, such as, transition metals including Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, Au, Rf, Db, Sg, Bh, Hs (i.e., transition metals contained in groups 3-11 of the periodic table) and combinations thereof, alkali and alkaline earth metal components, such as, Li, Be, Na, Mg, K, Ca, Rb, Sr, Cs, Ba, and combinations thereof; carbon, metal organic framework (MOF) or combinations thereof.

Embodiment 59. The system of embodiment 57, wherein the batch of porous adsorbent filaments comprises a lithium aluminate, wherein the batch of porous adsorbent filaments comprises a 2-layer lithium aluminate, wherein the batch of porous adsorbent filaments comprises (LiCl)ₓ·2Al(OH)₃,nH₂O, wherein the batch of porous adsorbent filaments comprises Li Bayerite.

Embodiment 60. The system of embodiment 57, wherein the batch of porous adsorbent filaments comprises a moisture content of at least about 20 wt. % based on a total weight of the batch of porous adsorbent filaments, such as, at least about 21 wt. % or at least about 22 wt. % or at least about 23 wt. % or at least about 24 wt. % or at least about 25 wt. % or at least about 26 wt. % or at least about 27 wt. % or at least about 28 wt. % or at least about 29 wt. % or at least about 30 wt. % or at least about 31 wt. % or at least about 32 wt. % or at least about 33 wt. % or at least about 34 wt. % or at least about 35 wt. % or at least about 36 wt. % or at least about 37 wt. % or at least about 38 wt. % or at least about 39 wt. % or at least about 40 wt. % or at least about 41 wt. % or at least about 42 wt. % or at least about 43 wt. % or at least about 44 wt. % or at least about 45 wt. %.

Embodiment 61. The system of embodiment 57, wherein the batch of porous adsorbent filaments comprises a moisture content of not greater than about 60 wt. % based on a total weight of the batch of porous adsorbent filaments or not greater than about 58 wt. % or not greater than about 56 wt. % or not greater than about 54 wt. % or not greater than about 52 wt. % or not greater than about 50 wt. %.

Embodiment 62. The system of embodiment 57, wherein the batch of porous adsorbent filaments comprises an envelope density of at least about 0.9 g/cm³.

Embodiment 63. The system of embodiment 57, wherein the batch of porous adsorbent filaments comprises an envelope density of not greater than about 2.0 g/cm³.

Embodiment 64. The system of embodiment 57, wherein the batch of porous adsorbent filaments comprises a plurality of filaments having a columnar shape.

Embodiment 65. The system of embodiment 57, wherein the batch of porous adsorbent filaments comprises a plurality of filaments having a circular cross-sectional shape.

Embodiment 66. The system of embodiment 57, wherein the batch of porous adsorbent filaments comprises a plurality of filaments having an oval cross-sectional shape.

Embodiment 67. The system of embodiment 57, wherein the batch of porous adsorbent filaments comprises a plurality of filaments having a polygonal cross-sectional shape.

Embodiment 68. The system of embodiment 57, wherein the batch of porous adsorbent filaments has a filament aspect ratio (L/D) distribution span PARDS of not greater than about 50%, where PARDS is equal to (AR90−AR10)/AR50, where AR90 is equal to a AR90 filament aspect ratio (L/D) distribution measurement of the batch of porous adsorbent filaments, AR10 is equal to a AR10 filament aspect ratio (L/D) distribution measurement, AR50 is equal to a AR50 filament aspect ratio (L/D) distribution measurement.

Embodiment 69. The system of embodiment 57, wherein the batch of porous adsorbent filaments has an average filament diameter of not greater than about 5 mm.

Embodiment 70. The system of embodiment 57, wherein the batch of porous adsorbent filaments has an average filament diameter of at least about 0.01 mm.

Embodiment 71. The system of embodiment 57, wherein the batch of porous adsorbent filaments has an average filament length of at least about 0.01 mm.

Embodiment 72. The system of embodiment 57, wherein the batch of porous adsorbent filaments has an average filament length of not greater than about 10 mm.

Embodiment 73. The system of embodiment 57, wherein the batch of porous adsorbent filaments has an average aspect ratio (L/D) of not greater than about 20.

Embodiment 74. The system of embodiment 57, wherein the batch of porous adsorbent filaments has an average aspect ratio (L/D) of at least about 0.5.

Embodiment 75. The system of embodiment 57, wherein the porous adsorbent filaments of the batch of porous adsorbent filaments are porous solid filaments configured for uptake and immobilization of a species from a surrounding medium by one or more adsorption processes.

Embodiment 76. The system of embodiment 57, wherein the porous adsorbent filaments of the batch of porous adsorbent filaments are further configured for desorption of the species from the surrounding medium subsequent to uptake and immobilization of the species.

Embodiment 77. The system of embodiment 57, wherein the porous adsorbent filaments are not configured for use as abrasive filaments.

Embodiment 78. The system of embodiment 57, wherein the porous adsorbent filaments are not abrasive filaments.

Embodiment 79. The system of embodiment 57, wherein the porous adsorbent filaments can not be configured for use in material removal through a grinding operation.

Embodiment 80. The system of embodiment 57, wherein the porous adsorbent filaments can not be configured for use in material removal through a grinding operation of a workpiece having a Vickers hardness of at least about 11 GPa, at least about 10 GPa, at least about 5 GPa.

Embodiment 81. The system of embodiment 57, wherein the porous adsorbent filaments have a hardness that is not greater than a hardness of abrasive filaments.

Embodiment 82. The system of embodiment 57, wherein the porous adsorbent filaments have a Mohs hardness that is not greater than a Mohs hardness of abrasive filaments.

Embodiment 83. The system of embodiment 57, wherein the porous adsorbent filaments have a Mohs hardness of not greater than about 7, not greater than about 6, not greater than about 5, not greater than about 4, not greater than about 3, not greater than about 2, not greater than about 1.

Embodiment 84. The system of embodiment 57, wherein the porous adsorbent filaments have a Vickers hardness that is not greater than a Vickers hardness of abrasive filaments.

Embodiment 85. The system of embodiment 57, wherein the porous adsorbent filaments have a Vickers hardness of not greater than about 11 GPa, not greater than about 10, not greater than about 5.

Embodiment 86. A method of forming a batch of porous lithium bayerite adsorbent filaments, wherein the method comprises: providing a precursor mixture, forcing the precursor mixture at a fixed rate through an orifice and then through a multiplicity of perforations in a belt, wherein the belt moves across and in tight registry with said orifice to form a batch of precursor porous adsorbent filaments, and drying the batch of precursor porous adsorbent filaments to form the batch of porous adsorbent filaments, wherein the batch of porous lithium bayerite adsorbent filaments comprises a moisture content of at least about 20 wt. %.

Embodiment 87. The method of embodiment 86, wherein the precursor mixture comprises ceramic components, such as, aluminas, boehmites, bayerites, aluminum hydroxides, silicas, titanias, zirconias, and combinations thereof, metal components, such as, transition metals including Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, Au, Rf, Db, Sg, Bh, Hs (i.e., transition metals contained in groups 3-11 of the periodic table) and combinations thereof, alkali and alkaline earth metal components, such as, Li, Be, Na, Mg, K, Ca, Rb, Sr, Cs, Ba, and combinations thereof; alumina, carbon, metal organic framework (MOF) or combinations thereof.

Embodiment 88. The method of embodiment 86, wherein the batch of porous lithium bayerite adsorbent filaments comprises a lithium aluminate, wherein the batch of porous lithium bayerite adsorbent filaments comprises a 2-layer lithium aluminate, wherein the batch of porous lithium bayerite adsorbent filaments comprises (LiCl)ₓ·2Al(OH)₃,nH₂O, wherein the batch of porous lithium bayerite adsorbent filaments comprises lithium bayerite.

Embodiment 89. The method of embodiment 86, wherein the batch of porous lithium bayerite adsorbent filaments comprises a moisture content of at least about 20 wt. % based on a total weight of the batch of porous lithium bayerite adsorbent filaments, such as, at least about 21 wt. % or at least about 22 wt. % or at least about 23 wt. % or at least about 24 wt. % or at least about 25 wt. % or at least about 26 wt. % or at least about 27 wt. % or at least about 28 wt. % or at least about 29 wt. % or at least about 30 wt. % or at least about 31 wt. % or at least about 32 wt. % or at least about 33 wt. % or at least about 34 wt. % or at least about 35 wt. % or at least about 36 wt. % or at least about 37 wt. % or at least about 38 wt. % or at least about 39 wt. % or at least about 40 wt. % or at least about 41 wt. % or at least about 42 wt. % or at least about 43 wt. % or at least about 44 wt. % or at least about 45 wt. %.

Embodiment 90. The method of embodiment 86, wherein the batch of porous lithium bayerite adsorbent filaments comprises a moisture content of not greater than about 60 wt. % based on a total weight of the batch of porous lithium bayerite adsorbent filaments or not greater than about 58 wt. % or not greater than about 56 wt. % or not greater than about 54 wt. % or not greater than about 52 wt. % or not greater than about 50 wt. %.

Embodiment 91. The method of embodiment 86, wherein the batch of porous lithium bayerite adsorbent filaments comprises an envelope density of at least about 0.9 g/cm³.

Embodiment 92. The method of embodiment 86, wherein the batch of porous lithium bayerite adsorbent filaments comprises an envelope density of not greater than about 2.0 g/cm³.

Embodiment 93. The method of embodiment 86, wherein the batch of porous lithium bayerite adsorbent filaments comprises a plurality of filaments having a columnar shape.

Embodiment 94. The method of embodiment 86, wherein the batch of porous lithium bayerite adsorbent filaments comprises a plurality of filaments having a circular cross-sectional shape.

Embodiment 95. The method of embodiment 86, wherein the batch of porous lithium bayerite adsorbent filaments comprises a plurality of filaments having an oval cross-sectional shape.

Embodiment 96. The method of embodiment 86, wherein the batch of porous lithium bayerite adsorbent filaments comprises a plurality of filaments having a polygonal cross-sectional shape.

Embodiment 97. The method of embodiment 86, wherein the batch of porous lithium bayerite adsorbent filaments have an average filament diameter of not greater than about 5 mm and a filament aspect ratio (L/D) distribution span PARDS of not greater than about 50%, where PARDS is equal to (AR90−AR10)/AR50, where AR90 is equal to a AR90 filament aspect ratio (L/D) distribution measurement of the batch of porous lithium bayerite adsorbent filaments, AR10 is equal to a AR10 filament aspect ratio (L/D) distribution measurement, and AR50 is equal to a AR50 filament aspect ratio (L/D) distribution measurement.

Embodiment 98. The method of embodiment 86, wherein the batch of porous lithium bayerite adsorbent filaments has an average filament diameter of not greater than about 5 mm.

Embodiment 99. The method of embodiment 86, wherein the batch of porous lithium bayerite adsorbent filaments has an average filament diameter of at least about 0.01 mm.

Embodiment 100. The method of embodiment 86, wherein the batch of porous lithium bayerite adsorbent filaments has an average filament length of at least about 0.01 mm.

Embodiment 101. The method of embodiment 86, wherein the batch of porous lithium bayerite adsorbent filaments has an average filament length of not greater than about 10 mm.

Embodiment 102. The method of embodiment 86, wherein the batch of porous lithium bayerite adsorbent filaments has an average aspect ratio (L/D) of not greater than about 20.

Embodiment 103. The method of embodiment 86, wherein the batch of porous lithium bayerite adsorbent filaments has an average aspect ratio (L/D) of at least about 0.5.

Embodiment 104. The method of embodiment 86, wherein the porous lithium bayerite adsorbent filaments of the batch of porous lithium bayerite adsorbent filaments are porous solid filaments configured for uptake and immobilization of a species from a surrounding medium by one or more adsorption processes.

Embodiment 105. The method of embodiment 86, wherein the porous lithium bayerite adsorbent filaments of the batch of porous lithium bayerite adsorbent filaments are further configured for desorption of the species from the surrounding medium subsequent to uptake and immobilization of the species.

Embodiment 106. The method of embodiment 86, wherein the porous lithium bayerite adsorbent filaments are not configured for use as abrasive filaments.

Embodiment 107. The method of embodiment 86, wherein the porous lithium bayerite adsorbent filaments are not abrasive filaments.

Embodiment 108. The method of embodiment 86, wherein the porous lithium bayerite adsorbent filaments cannot be configured for use in material removal through a grinding operation.

Embodiment 109. The method of embodiment 86, wherein the porous lithium bayerite adsorbent filaments cannot be configured for use in material removal through a grinding operation of a workpiece having a Vickers hardness of at least about 5 GPa, at least about 10 GPa, at least about 11 GPa.

Embodiment 110. The method of embodiment 86, wherein the porous lithium bayerite adsorbent filaments have a hardness not greater than a hardness of abrasive filaments.

Embodiment 111. The method of embodiment 86, wherein the porous lithium bayerite adsorbent filaments have a Mohs hardness that is not greater than a Mohs hardness of abrasive filaments.

Embodiment 112. The method of embodiment 86, wherein the porous lithium bayerite adsorbent filaments have a Mohs hardness of not greater than about 7, not greater than about 6, not greater than about 5, not greater than about 4, not greater than about 3, not greater than about 2, not greater than about 1.

Embodiment 113. The method of embodiment 86, wherein the porous lithium bayerite adsorbent filaments have a Vickers hardness that is not greater than a Vickers hardness of abrasive filaments.

Embodiment 114. The method of embodiment 86, wherein the porous lithium bayerite adsorbent filaments have a Vickers hardness of not greater than about 11 GPa, not greater than about 10 GPa, not greater than about 5 GPa.

Embodiment 115. A batch of porous lithium bayerite adsorbent filaments comprising an average aspect ratio (L/D) of at least about 0.5 and a wherein the batch of porous lithium bayerite adsorbent filaments comprises a moisture content of at least about 20 wt. %.

Embodiment 116. The batch of porous lithium bayerite adsorbent filaments of embodiment 115, wherein the batch of porous lithium bayerite adsorbent filaments comprises a lithium aluminate, wherein the batch of porous lithium bayerite adsorbent filaments comprises a 2-layer lithium aluminate, wherein the batch of porous lithium bayerite adsorbent filaments comprises (LiCl)ₓ·2Al(OH)₃,nH₂O, wherein the batch of porous lithium bayerite adsorbent filaments comprises Li Bayerite.

Embodiment 117. The batch of porous lithium bayerite adsorbent filaments of embodiment 115, wherein the batch of porous lithium bayerite adsorbent filaments comprises a moisture content of at least about 20 wt. % based on a total weight of the batch of porous lithium bayerite adsorbent filaments, such as, at least about 21 wt. % or at least about 22 wt. % or at least about 23 wt. % or at least about 24 wt. % or at least about 25 wt. % or at least about 26 wt. % or at least about 27 wt. % or at least about 28 wt. % or at least about 29 wt. % or at least about 30 wt. % or at least about 31 wt. % or at least about 32 wt. % or at least about 33 wt. % or at least about 34 wt. % or at least about 35 wt. % or at least about 36 wt. % or at least about 37 wt. % or at least about 38 wt. % or at least about 39 wt. % or at least about 40 wt. % or at least about 41 wt. % or at least about 42 wt. % or at least about 43 wt. % or at least about 44 wt. % or at least about 45 wt. %.

Embodiment 118. The batch of porous lithium bayerite adsorbent filaments of embodiment 115, wherein the batch of porous lithium bayerite adsorbent filaments comprises a moisture content of not greater than about 60 wt. % based on a total weight of the batch of porous lithium bayerite adsorbent filaments or not greater than about 58 wt. % or not greater than about 56 wt. % or not greater than about 54 wt. % or not greater than about 52 wt. % or not greater than about 50 wt. %.

Embodiment 119. The batch of porous lithium bayerite adsorbent filaments of embodiment 115, wherein the batch of porous lithium bayerite adsorbent filaments comprises an envelope density of at least about 0.9 g/cm³.

Embodiment 120. The batch of porous lithium bayerite adsorbent filaments of embodiment 115, wherein the batch of porous lithium bayerite adsorbent filaments comprises an envelope density of not greater than about 2.0 g/cm³.

Embodiment 121. The batch of porous lithium bayerite adsorbent filaments of embodiment 115, wherein the batch of porous lithium bayerite adsorbent filaments comprises a plurality of filaments having a columnar shape.

Embodiment 122. The batch of porous lithium bayerite adsorbent filaments of embodiment 115, wherein the batch of porous lithium bayerite adsorbent filaments comprises a plurality of filaments having a circular cross-sectional shape.

Embodiment 123. The batch of porous lithium bayerite adsorbent filaments of embodiment 115, wherein the batch of porous lithium bayerite adsorbent filaments comprises a plurality of filaments having an oval cross-sectional shape.

Embodiment 124. The batch of porous lithium bayerite adsorbent filaments of embodiment 115, wherein the batch of porous lithium bayerite adsorbent filaments comprises a plurality of filaments having a polygonal cross-sectional shape.

Embodiment 125. The batch of porous lithium bayerite adsorbent filaments of embodiment 115, wherein the batch of porous lithium bayerite adsorbent filaments has an average filament diameter of not greater than about 5 mm.

Embodiment 126. The batch of porous lithium bayerite adsorbent filaments of embodiment 115, wherein the batch of porous lithium bayerite adsorbent filaments has an average filament diameter of at least about 0.01 mm.

Embodiment 127. The batch of porous lithium bayerite adsorbent filaments of embodiment 115, wherein the batch of porous lithium bayerite adsorbent filaments has an average filament length of at least about 0.01 mm.

Embodiment 128. The batch of porous lithium bayerite adsorbent filaments of embodiment 115, wherein the batch of porous lithium bayerite adsorbent filaments has an average filament length of not greater than about 10 mm.

Embodiment 129. The batch of porous lithium bayerite adsorbent filaments of embodiment 115, wherein the batch of porous lithium bayerite adsorbent filaments has an average aspect ratio (L/D) of not greater than about 20.

Embodiment 130. The batch of porous lithium bayerite adsorbent filaments of embodiment 115, wherein the batch of porous lithium bayerite adsorbent filaments has an average aspect ratio (L/D) of at least about 0.5.

Embodiment 131. The batch of porous lithium bayerite adsorbent filaments of embodiment 115, wherein the porous lithium bayerite adsorbent filaments of the batch of porous lithium bayerite adsorbent filaments are porous solid filaments configured for uptake and immobilization of a species from a surrounding medium by one or more adsorption processes.

Embodiment 132. The batch of porous lithium bayerite adsorbent filaments of embodiment 115, wherein the porous lithium bayerite adsorbent filaments of the batch of porous lithium bayerite adsorbent filaments are further configured for desorption of the species from the surrounding medium subsequent to uptake and immobilization of the species.

Embodiment 133. The batch of porous lithium bayerite adsorbent filaments of embodiment 115, wherein the porous lithium bayerite adsorbent filaments are not configured for use as abrasive filaments.

Embodiment 134. The batch of porous lithium bayerite adsorbent filaments of embodiment 115, wherein the porous lithium bayerite adsorbent filaments are not abrasive filaments.

Embodiment 135. The batch of porous lithium bayerite adsorbent filaments of embodiment 115, wherein the porous lithium bayerite adsorbent filaments cannot be configured for use in material removal through a grinding operation.

Embodiment 136. The batch of porous lithium bayerite adsorbent filaments of embodiment 115, wherein the porous lithium bayerite adsorbent filaments cannot be configured for use in material removal through a grinding operation of a workpiece having a Vickers hardness of at least about 11 GPa, at least about 10 GPa, at least about 5 GPa.

Embodiment 137. The batch of porous lithium bayerite adsorbent filaments of embodiment 115, wherein the porous lithium bayerite adsorbent filaments have a hardness that is not greater than a hardness of abrasive filaments.

Embodiment 138. The batch of porous lithium bayerite adsorbent filaments of embodiment 115, wherein the porous lithium bayerite adsorbent filaments have a Mohs hardness that is not greater than a Mohs hardness of abrasive filaments.

Embodiment 139. The batch of porous lithium bayerite adsorbent filaments of embodiment 115, wherein the porous lithium bayerite adsorbent filaments have a Mohs hardness of not greater than about 7, not greater than about 6, not greater than about 5, not greater than about 4, not greater than about 3, not greater than about 2, not greater than about 1.

Embodiment 140. The batch of porous lithium bayerite adsorbent filaments of embodiment 115, wherein the porous lithium bayerite adsorbent filaments have a Vickers hardness that is not greater than a Vickers hardness of abrasive filaments.

Embodiment 141. The batch of porous lithium bayerite adsorbent filaments of embodiment 115, wherein the porous lithium bayerite adsorbent filaments have a Vickers hardness of not greater than about 11 GPa, not greater than about 10 GPa, not greater than about 5 GPa.

Embodiment 142. A system for forming a batch of porous lithium bayerite adsorbent filaments, wherein the system comprises: an application zone comprising a shaping assembly including a reservoir configure to force a precursor mixture at a fixed rate through an orifice and then through a multiplicity of perforations in a belt, wherein the belt moves across and in tight registry with said orifice to form a batch of precursor porous adsorbent filaments, and a drying zone comprising a first heat source and being configured to dry the batch of precursor porous lithium bayerite adsorbent filaments to form the batch of porous adsorbent filaments.

Embodiment 143. The system of embodiment 142, wherein the precursor mixture comprises ceramic components, such as, aluminas, boehmites, bayerites, aluminum hydroxides, silicas, titanias, zirconias, and combinations thereof, metal components, such as, transition metals including Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, Au, Rf, Db, Sg, Bh, Hs (i.e., transition metals contained in groups 3-11 of the periodic table) and combinations thereof, alkali and alkaline earth metal components, such as, Li, Be, Na, Mg, K, Ca, Rb, Sr, Cs, Ba, and combinations thereof; alumina, carbon, metal organic framework (MOF) or combinations thereof.

Embodiment 144. The system of embodiment 142, wherein the batch of porous lithium bayerite adsorbent filaments comprises a lithium aluminate, wherein the batch of porous lithium bayerite adsorbent filaments comprises a 2-layer lithium aluminate, wherein the batch of porous lithium bayerite adsorbent filaments comprises (LiCl)ₓ·2Al(OH)₃,nH₂O, wherein the batch of porous lithium bayerite adsorbent filaments comprises Li Bayerite.

Embodiment 145. The system of embodiment 142, wherein the batch of porous lithium bayerite adsorbent filaments comprises a moisture content of at least about 20 wt. % based on a total weight of the batch of porous lithium bayerite adsorbent filaments, such as, at least about 21 wt. % or at least about 22 wt. % or at least about 23 wt. % or at least about 24 wt. % or at least about 25 wt. % or at least about 26 wt. % or at least about 27 wt. % or at least about 28 wt. % or at least about 29 wt. % or at least about 30 wt. % or at least about 31 wt. % or at least about 32 wt. % or at least about 33 wt. % or at least about 34 wt. % or at least about 35 wt. % or at least about 36 wt. % or at least about 37 wt. % or at least about 38 wt. % or at least about 39 wt. % or at least about 40 wt. % or at least about 41 wt. % or at least about 42 wt. % or at least about 43 wt. % or at least about 44 wt. % or at least about 45 wt. %.

Embodiment 146. The system of embodiment 142, wherein the batch of porous lithium bayerite adsorbent filaments comprises a moisture content of not greater than about 60 wt. % based on a total weight of the batch of porous lithium bayerite adsorbent filaments or not greater than about 58 wt. % or not greater than about 56 wt. % or not greater than about 54 wt. % or not greater than about 52 wt. % or not greater than about 50 wt. %.

Embodiment 147. The system of embodiment 142, wherein the batch of porous lithium bayerite adsorbent filaments comprises an envelope density of at least about 0.9 g/cm³.

Embodiment 148. The system of embodiment 142, wherein the batch of porous lithium bayerite adsorbent filaments comprises an envelope density of not greater than about 2.0 g/cm³.

Embodiment 149. The system of embodiment 142, wherein the batch of porous lithium bayerite adsorbent filaments comprises a plurality of filaments having a columnar shape.

Embodiment 150. The system of embodiment 142, wherein the batch of porous lithium bayerite adsorbent filaments comprises a plurality of filaments having a circular cross-sectional shape.

Embodiment 151. The system of embodiment 142, wherein the batch of porous lithium bayerite adsorbent filaments comprises a plurality of filaments having an oval cross-sectional shape.

Embodiment 152. The system of embodiment 142, wherein the batch of porous lithium bayerite adsorbent filaments comprises a plurality of filaments having a polygonal cross-sectional shape.

Embodiment 153. The system of embodiment 142, wherein the batch of porous lithium bayerite adsorbent filaments has a filament aspect ratio (L/D) distribution span PARDS of not greater than about 50%, where PARDS is equal to (AR90−AR10)/AR50, where AR90 is equal to a AR90 filament aspect ratio (L/D) distribution measurement of the batch of porous lithium bayerite adsorbent filaments, AR10 is equal to a AR10 filament aspect ratio (L/D) distribution measurement, AR50 is equal to a AR50 filament aspect ratio (L/D) distribution measurement.

Embodiment 154. The system of embodiment 142, wherein the batch of porous lithium bayerite adsorbent filaments has an average filament diameter of not greater than about 5 mm.

Embodiment 155. The system of embodiment 142, wherein the batch of porous lithium bayerite adsorbent filaments has an average filament diameter of at least about 0.01 mm.

Embodiment 156. The system of embodiment 142, wherein the batch of porous lithium bayerite adsorbent filaments has an average filament length of at least about 0.01 mm.

Embodiment 157. The system of embodiment 142, wherein the batch of porous lithium bayerite adsorbent filaments has an average filament length of not greater than about 10 mm.

Embodiment 158. The system of embodiment 142, wherein the batch of porous lithium bayerite adsorbent filaments has an average aspect ratio (L/D) of not greater than about 20.

Embodiment 159. The system of embodiment 142, wherein the batch of porous lithium bayerite adsorbent filaments has an average aspect ratio (L/D) of at least about 0.5.

Embodiment 160. The system of embodiment 142, wherein the porous lithium bayerite adsorbent filaments of the batch of porous lithium bayerite adsorbent filaments are porous solid filaments configured for uptake and immobilization of a species from a surrounding medium by one or more adsorption processes.

Embodiment 161. The system of embodiment 142, wherein the porous lithium bayerite adsorbent filaments of the batch of porous lithium bayerite adsorbent filaments are further configured for desorption of the species from the surrounding medium subsequent to uptake and immobilization of the species.

Embodiment 162. The system of embodiment 142, wherein the porous lithium bayerite adsorbent filaments are not configured for use as abrasive filaments.

Embodiment 163. The system of embodiment 142, wherein the porous lithium bayerite adsorbent filaments are not abrasive filaments.

Embodiment 164. The system of embodiment 142, wherein the porous lithium bayerite adsorbent filaments cannot be configured for use in material removal through a grinding operation.

Embodiment 165. The system of embodiment 142, wherein the porous lithium bayerite adsorbent filaments cannot be configured for use in material removal through a grinding operation of a workpiece having a Vickers hardness of at least about 11 GPa, at least about 10 GPa, at least about 5 GPa.

Embodiment 166. The system of embodiment 142, wherein the porous lithium bayerite adsorbent filaments have a hardness that is not greater than a hardness of abrasive filaments.

Embodiment 167. The system of embodiment 142, wherein the porous lithium bayerite adsorbent filaments have a Mohs hardness that is not greater than a Mohs hardness of abrasive filaments.

Embodiment 168. The system of embodiment 142, wherein the porous lithium bayerite adsorbent filaments have a Mohs hardness of not greater than about 7, not greater than about 6, not greater than about 5, not greater than about 4, not greater than about 3, not greater than about 2, not greater than about 1.

Embodiment 169. The system of embodiment 142, wherein the porous lithium bayerite adsorbent filaments have a Vickers hardness that is not greater than a Vickers hardness of abrasive filaments.

Embodiment 170. The system of embodiment 142, wherein the porous lithium bayerite adsorbent filaments have a Vickers hardness of not greater than about 11 GPa, not greater than about 10, not greater than about 5.

In the foregoing, reference to specific embodiments and the connections of certain components is illustrative. It will be appreciated that reference to components as being coupled or connected is intended to disclose either direct connection between said components or indirect connection through one or more intervening components as will be appreciated to carry out the methods as discussed herein. As such, the above-disclosed subject matter is to be considered illustrative, and not restrictive, and the appended claims are intended to cover all such modifications, enhancements, and other embodiments, which fall within the true scope of the present invention. Moreover, not all of the activities described above in the general description or the examples are required, that a portion of a specific activity cannot be required, and that one or more further activities can be performed in addition to those described. Still further, the order in which activities are listed is not necessarily the order in which they are performed.

The disclosure is submitted with the understanding that it will not be used to limit the scope or meaning of the claims. In addition, in the foregoing disclosure, certain features that are, for clarity, described herein in the context of separate embodiments, can also be provided in combination in a single embodiment. Conversely, various features that are, for brevity, described in the context of a single embodiment, can also be provided separately or in any subcombination. Still, the inventive subject matter can be directed to less than all features of any of the disclosed embodiments.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, or essential feature of any or all the claims.

Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of forming a batch of porous adsorbent filaments, wherein the method comprises:
providing a precursor mixture,
forcing the precursor mixture at a fixed rate through an orifice and then through a multiplicity of perforations in a belt, wherein the belt moves across and in tight registry with said orifice to form a batch of precursor porous adsorbent filaments, and
drying the batch of precursor porous adsorbent filaments to form the batch of porous adsorbent filaments,
wherein the batch of porous adsorbent filaments comprises a moisture content of at least about 20 wt. %.

2. The method of claim 1, wherein the precursor mixture comprises a ceramic component.

3. The method of claim 1, wherein the batch of porous adsorbent filaments comprises a lithium aluminate.

4. The method of claim 1, wherein the batch of porous adsorbent filaments comprises a moisture content of at least about 30 wt. % based on a total weight of the batch of porous adsorbent filaments.

5. The method of claim 1, wherein the batch of porous adsorbent filaments comprises a moisture content of not greater than about 60 wt. % based on a total weight of the batch of porous adsorbent filaments.

6. The method of claim 1, wherein the batch of porous adsorbent filaments comprises an envelope density of at least about 0.9 g/cm³ and not greater than about 2.0 g/cm³.

7. The method of claim 1, wherein the batch of porous adsorbent filaments comprises a plurality of filaments having a columnar shape.

8. The method of claim 1, wherein the batch of porous adsorbent filaments has an average filament diameter of not greater than about 5 mm and a filament aspect ratio (L/D) distribution span PARDS of not greater than about 50%, where PARDS is equal to (AR₉₀−AR₁₀)/AR₅₀, where AR₉₀ is equal to a AR₉₀ filament aspect ratio (L/D) distribution measurement of the batch of porous adsorbent filaments, AR₁₀ is equal to a AR₁₀ filament aspect ratio (L/D) distribution measurement, and AR₅₀ is equal to a AR₅₀ filament aspect ratio (L/D) distribution measurement.

9. The method of claim 1, wherein the batch of porous adsorbent filaments has an average filament diameter of not greater than about 5 mm.

10. The method of claim 1, wherein the batch of porous adsorbent filaments has an average filament length of at least about 0.01 mm.

11. The method of claim 1, wherein the porous adsorbent filaments have a Mohs hardness that is not greater than a Mohs hardness of abrasive filaments.

12. A batch of porous adsorbent filaments comprising an average aspect ratio (L/D) of at least about 0.5 and a wherein the batch of porous adsorbent filaments comprises a moisture content of at least about 20 wt. %.

13. The batch of porous adsorbent filaments of claim 12, wherein the batch of porous adsorbent filaments comprises a lithium aluminate, wherein the batch of porous adsorbent filaments comprises a 2-layer lithium aluminate, wherein the batch of porous adsorbent filaments comprises (LiCl)ₓ·2Al(OH)₃,nH₂O, wherein the batch of porous adsorbent filaments comprises Li Bayerite.

14. The batch of porous adsorbent filaments of claim 12, wherein the batch of porous adsorbent filaments comprises a plurality of filaments having a columnar shape.

15. A system for forming a batch of porous adsorbent filaments, wherein the system comprises: an application zone comprising a shaping assembly including a reservoir configured to force a precursor mixture at a fixed rate through an orifice and then through a multiplicity of perforations in a belt, wherein the belt moves across and in tight registry with said orifice to form a batch of precursor porous adsorbent filaments, and a drying zone comprising a first heat source and being configured to dry the batch of precursor porous adsorbent filaments to form the batch of porous adsorbent filaments.
